(19) United States
(12) Patent Application Publication
(10) Pub. No.: US 2024/0276215 A1
(43) Pub. Date: Aug. 15, 2024

(54) Serving Network Authentication of a Communication Device

(71) Applicant: Telefonaktiebolaget LM Ericsson (publ), Stockholm (SE)

(72) Inventors: Prajwol Kumar Nakarmi, Solna (SE); Vesa Lehtovirta, Espoo (FI); Jari Arkko, Kauniainen (FI)

(21) Appl. No.: 18/565,740

(22) PCT Filed: Jun. 1, 2022
(86) PCT No.: PCT/EP2022/064918

§ 371 Date: Nov. 30, 2023

Related U.S. Application Data
(60) Provisional application No. 63/197,164, filed on Jun. 4, 2021.
(60) Provisional application No. 63/209,186, filed on Jun. 10, 2021.

(51) Int. Cl. H04W 12/06; H04L 9/32

(52) U.S. Cl. CPC H04W 12/06; H04L 9/3271

(57) ABSTRACT

Security anchor equipment (20) relays Extensible Authentication Protocol, EAP, messages (12M) between a communication device (10) and an authentication server (30) that is operating as an EAP server for an EAP Authentication and Key Agreement, AKA, procedure (12) between the communication device (10) and the authentication server (30). The security anchor equipment (20) receives, from the communication device (10), a response (16) to a challenge (14). The security anchor equipment (20) checks whether the response (16) corresponds to an expected response (18) as part of an attempt by the security anchor equipment (20) to authenticate the communication device (10). In some embodiments, at least one of the response (16), the challenge (14), and the expected response (18) is, or is derived using, information used in the EAP AKA procedure (12) between the communication device (10) and the authentication server (30).

### TECHNICAL FIELD

The present application relates generally to a communication network, and relates more particularly to serving network authentication of a communication device.

### BACKGROUND

A communication device typically receives communication service from a communication network on the basis of a subscription to the communication network. The network to which the communication device holds a subscription is referred to as the home network of the communication device. For these and other reasons, the home network requires a communication device to authenticate itself to the home network in order for the communication device to receive communication service from the home network.

The home network may nonetheless enter into a roaming agreement with one or more other communication networks, so that the other communication network(s) can serve a communication device on the basis of the device's subscription to the home network, even when the communication device roams away from the coverage provided by the home network. In this case, too, the home network requires the communication device to authenticate itself to the home network in order for the communication device to receive communication service from the serving network to which the communication device has roamed.

Some approaches for authentication nonetheless have vulnerabilities, e.g., that leave the home network susceptible to a denial of service (DOS) attack. For example, when the home network uses the Extensible Authentication Protocol (EAP) to authenticate communication devices, the EAP server in the home network could be maliciously inundated with authentication requests, leading to overload of the EAP server. Alternatively or additionally, the randomness introduced by the home network for authentication may prove insufficient under some circumstances, e.g., in ensuring that authentication is fresh.

### SUMMARY

According to some embodiments herein, security anchor equipment not only relays EAP messages between a communication device and an EAP server, but also itself authenticates a communication device. With the security anchor equipment located in the communication device's serving network, then, this effectively enables the serving network to authenticate the communication device even in a context where EAP is used to authenticate the communication device to the home network. In fact, in some embodiments, rather than just naively relaying EAP messages between the communication device and the EAP server, the security anchor equipment may reject the communication device's attempt to authenticate with the home network if the communication device's attempt to authenticate with the serving network fails. The security anchor equipment in doing so may advantageously protect the EAP server from overload and/or denial of service attacks.

According to other embodiments herein, security anchor equipment alternatively or additionally contributes randomness to authentication of a communication device. The security anchor equipment in this regard may generate a random token to be used for authentication of the communication device, e.g., by the security anchor equipment and/or an authentication server. With the security anchor function in the communication device's serving network, the serving network may supplement the home network's randomness so as to better ensure authentication is fresh.

More particularly, embodiments herein include a method performed by security anchor equipment. The method comprises relaying Extensible Authentication Protocol, EAP, messages between a communication device and an authentication server that is operating as an EAP server for an EAP Authentication and Key Agreement, AKA, procedure between the communication device and the authentication server. The method also comprises receiving, from the communication device, a response to a challenge. The method also comprises checking, by the security anchor equipment, whether the response corresponds to an expected response as part of an attempt by the security anchor equipment to authenticate the communication device. In some embodiments, at least one of the response, the challenge, and the expected response is, or is derived using, information used in the EAP AKA procedure between the communication device and the authentication server.

In some embodiments, information used in the EAP AKA procedure between the communication device and the authentication server includes a random token RAND. In some embodiments, at least one of the response, the challenge, and the expected response is, or is derived using, the random token RAND. In one or more of these embodiments, the challenge is the random token RAND. In one or more of these embodiments, the response and/or the expected response is derived using the random token RAND. In one or more of these embodiments, the method further comprises receiving the random token RAND from the authentication server. In one or more of these embodiments, checking whether the response corresponds to the expected response comprises generating a response token from the response and the random token RAND. Checking whether the response corresponds to the expected response also comprises checking whether the response token is equal to the expected response. In one or more of these embodiments, the method further comprises receiving an EAP AKA message from the authentication server and retrieving the random token RAND from the EAP AKA message. In one or more of these embodiments, the random token RAND is received in a message that is not an EAP AKA message. In one or more of these embodiments, the random token RAND is received in an Authentication, Authorization, and Accounting, AAA, message. Alternatively, the random token RAND is received in Serviced-Based Architecture, SBA, data carried in an application layer message.

In some embodiments, information used in the EAP AKA procedure between the communication device and the authentication server includes a cryptographic key. In some embodiments, the response and/or the expected response is derived using the cryptographic key. In one or more of these embodiments, the cryptographic key is shared between, or is generatable by each of, the communication device and the authentication server

In some embodiments, the expected response is derived using information used in the EAP AKA procedure between the communication device and the authentication server. In one or more of these embodiments, the response is a response RES* and wherein the expected response is an expected response HXRES*. In one or more of these embodiments, the response is a response CHECK* and wherein the expected response is an expected check value XCHECK*.

In some embodiments, the method further comprises receiving the expected response from the authentication server. In one or more of these embodiments, the expected response is received within an Authentication, Authorization, and Accounting, AAA, message. In one or more of these embodiments, the expected response is received within Serviced-Based Architecture, SBA, data carried in an application layer message.

In some embodiments, the method further comprises deriving the expected response from information used in the EAP AKA procedure between the communication device and the authentication server. In one or more of these embodiments, information used in the EAP AKA procedure between the communication device and the authentication server includes a random token RAND. In some embodiments, deriving the expected response comprises deriving the expected response from the random token RAND. In one or more of these embodiments, said deriving comprises deriving the expected response also using a random token generated by the security anchor equipment. In one or more of these embodiments, said deriving comprises deriving the expected response also using a cryptographic key received from the authentication server. In one or more of these embodiments, the method further comprises transmitting a request for the cryptographic key to the authentication server, and receiving the cryptographic key from the authentication server in response to the request.

In some embodiments, the response is received from the communication device in a Non-Access Stratum, NAS, message.

In some embodiments, the method further comprises receiving an EAP AKA message from the communication device and extracting the response from the EAP AKA message.

In some embodiments, the method further comprises transmitting, to the authentication server and/or to the communication device, signaling indicating a result of said checking by the security anchor equipment.

In some embodiments, the method further comprises authenticating or rejecting the communication device depending on a result of said checking.

In some embodiments, the challenge is a random token RAND* generated by the security anchor equipment.

In some embodiments, the expected response is derived using a random token RAND* generated by the security anchor equipment. In one or more of these embodiments, the method further comprises transmitting the random token RAND* to the authentication server.

In some embodiments, the security anchor equipment implements a Security Anchor Function, SEAF.

In some embodiments, the security anchor equipment is configured for use in a serving network of the communication device.

In some embodiments, the authentication server is configured for use in a home network of the communication device.

Embodiments herein also include a method performed by an authentication server. The method comprises exchanging Extensible Authentication Protocol, EAP, messages with a communication device as part of an EAP Authentication and Key Agreement, AKA, procedure between the communication device and the authentication server, with the authentication server operating as an EAP server. The method also comprises deriving, from information used in the EAP AKA procedure between the communication device and the authentication server, an expected response that security anchor equipment is to expect in response to a challenge as part of an attempt by the security anchor equipment to authenticate the communication device. The method also comprises transmitting the expected response to the security anchor equipment.

In some embodiments, information used in the EAP AKA procedure between the communication device and the authentication server includes a random token RAND. In some embodiments, the expected response is derived using the random token RAND. In one or more of these embodiments, the challenge is the random token RAND. In one or more of these embodiments, the method further comprises transmitting the random token RAND to the security anchor equipment in a message that is not an EAP AKA message. In one or more of these embodiments, the method further comprises transmitting the random token RAND to the security anchor equipment in an Authentication, Authorization, and Accounting, AAA, message. Alternatively, the method further comprises transmitting the random token RAND to the security anchor equipment in Serviced-Based Architecture, SBA, data carried in an application layer message.

In some embodiments, information used in the EAP AKA procedure between the communication device and the authentication server includes a cryptographic key. In some embodiments, the expected response is derived using the cryptographic key. In one or more of these embodiments, the cryptographic key is shared between, or is generatable by each of, the communication device and the authentication server.

In some embodiments, the expected response is an expected response HXRES*.

In some embodiments, the expected response is an expected check value XCHECK*.

In some embodiments, transmitting the expected response comprises transmitting the expected response to the security anchor equipment within a message that is not an EAP AKA message.

In some embodiments, transmitting the expected response comprises transmitting the expected response to the security anchor equipment within an Authentication, Authorization, and Accounting, AAA, message

In some embodiments, transmitting the expected response comprises transmitting the expected response to the security anchor equipment within Serviced-Based Architecture, SBA, data carried in an application layer message.

In some embodiments, said deriving comprises deriving the expected response also from a random token generated by the security anchor equipment. In one or more of these embodiments, the method further comprises receiving the random token from the security anchor equipment. In one or more of these embodiments, the random token is received in a message that is not an EAP AKA message. In one or more of these embodiments, the random token is received in an Authentication, Authorization, and Accounting, AAA, message. Alternatively, the random token is received in Serviced-Based Architecture, SBA, data carried in an application layer message.

In some embodiments, the method further comprises receiving, from the security anchor equipment, signaling indicating a result of the attempt by the security anchor equipment to authenticate the communication device. In one or more of these embodiments, the method further comprises authenticating or rejecting the communication device depending at least in part on the indicated result.

In some embodiments, the challenge is a random token RAND* generated by the security anchor equipment.

In some embodiments, the expected response is derived using a random token RAND* generated by the security anchor equipment. In one or more of these embodiments, the method further comprises receiving the random token RAND* from the security anchor equipment.

In some embodiments, the authentication server implements an Authentication Server Function, AUSF.

In some embodiments, the authentication server is configured for use in a home network of the communication equipment.

In some embodiments, the security anchor equipment is configured for use in a serving network of the communication equipment.

Embodiments herein further include a method performed by a communication device. The method comprises exchanging Extensible Authentication Protocol, EAP, messages with an authentication server as part of an EAP Authentication and Key Agreement, AKA, procedure between the communication device and the authentication server, with the authentication server operating as an EAP server. The method also comprises receiving a challenge from security anchor equipment. The method also comprises generating, from information used in the EAP AKA procedure between the communication device and the authentication server, a response to the challenge. The method also comprises transmitting the response to the security anchor equipment as part of an attempt to authenticate the communication device to the security anchor equipment.

In some embodiments, information used in the EAP AKA procedure between the communication device and the authentication server includes a random token RAND. In some embodiments, the response is derived using the random token RAND. In one or more of these embodiments, the challenge is the random token RAND.

In some embodiments, information used in the EAP AKA procedure between the communication device and the authentication server includes a cryptographic key. In some embodiments, the response is derived using the cryptographic key. In one or more of these embodiments, the cryptographic key is shared between, or is generatable by each of, the communication device and the authentication server.

In some embodiments, the response is a response RES*.

In some embodiments, the response is a response CHECK**.

In some embodiments, transmitting the response comprises transmitting the response to the security anchor equipment within an EAP AKA message.

In some embodiments, transmitting the response comprises transmitting the response to the security anchor equipment within a Non-Access Stratum, NAS, message.

In some embodiments, said deriving comprises deriving the response from a random token generated by the security anchor equipment. In one or more of these embodiments, the method further comprises receiving the random token from the security anchor equipment. In one or more of these embodiments, the random token is received within a Non-Access Stratum, NAS, message.

In some embodiments, the method further comprises receiving, from the security anchor equipment, signaling indicating a result of the attempt to authenticate the communication device to the security anchor equipment.

In some embodiments, the challenge is a random token RAND* generated by the security anchor equipment.

In some embodiments, the response is derived using a random token RAND* generated by the security anchor equipment. In one or more of these embodiments, the method further comprises receiving the random token RAND* from the security anchor equipment.

In some embodiments, the authentication server is configured for use in a home network of the communication equipment.

In some embodiments, the security anchor equipment is configured for use in a serving network of the communication equipment.

Embodiments herein also include corresponding apparatus, in the form of security anchor equipment, an authentication server, and a communication device configured to perform the respective methods described herein. Embodiments further include corresponding computer programs and carriers of those computer programs.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of authentication of a communication device according to some embodiments.

FIG. 2 is a block diagram of authentication of a communication device according to other embodiments.

FIG. 3 is a block diagram of authentication of a communication device according to yet other embodiments.

FIG. 4 is a block diagram of authentication of a communication device according to still other embodiments.

FIG. 5 is a block diagram of protocol stacks at a device, access network, serving core network, and home core network according to some embodiments.

FIG. 6A-6B is a block diagram of 5G Authentication and Key Agreement (AKA).

FIG. 7A-7B is a block diagram of 5G Extensible Authentication Protocol (EAP) Authentication and Key Agreement (AKA), 5G EAP-AKA′.

FIG. 8 is a call flow diagram for EAP-AKA′ according to some embodiments.

FIG. 9 is a call flow diagram for EAP-AKA′ according to other embodiments.

FIG. 10 is a call flow diagram for EAP-AKA according to yet other embodiments.

FIG. 11 is a block diagram of XCHECK* calculation according to some embodiments.

FIG. 12 is a call flow diagram for Enhanced 5G-AKA to some embodiments.

FIG. 13 is a call flow diagram for EAP-AKA′ according to still other embodiments.

FIG. 14 is a block diagram of XCHECK* calculation according to other embodiments.

FIG. 15 is a call flow diagram for Enhanced 5G-AKA to other embodiments.

FIG. 16A is a logic flow diagram of a method performed by a home network during a subscriber authentication according to some embodiments.

FIG. 16B is a logic flow diagram of a method performed by a serving network during a subscriber authentication according to some embodiments.

FIG. 16C is a logic flow diagram of a method performed by a UE according to some embodiments.

FIG. 17A is a logic flow diagram of a method performed by a home network during a subscriber authentication according to other embodiments.

FIG. 17B is a logic flow diagram of a method performed by a home network during a subscriber authentication according to other embodiments.

FIG. 17C is a logic flow diagram of a method performed by a UE according to other embodiments.

FIG. 18 is a logic flow diagram of a method performed by security anchor equipment according to some embodiments.

FIG. 19 is a logic flow diagram of a method performed an authentication server according to some embodiments.

FIG. 20 is a logic flow diagram of a method performed by a communication device according to some embodiments.

FIG. 21 is a logic flow diagram of a method performed by security anchor equipment according to other embodiments.

FIG. 22 is a logic flow diagram of a method performed an authentication server according to other embodiments.

FIG. 23 is a logic flow diagram of a method performed an authentication server according to yet other embodiments.

FIG. 24 is a logic flow diagram of a method performed by a communication device according to other embodiments.

FIG. 25 is a block diagram of a communication device according to some embodiments.

FIG. 26 is a block diagram of security anchor equipment according to some embodiments.

FIG. 27 is a block diagram of an authentication server according to some embodiments.

FIG. 28 is a block diagram of a communication system in accordance with some embodiments.

FIG. 29 is a block diagram of a user equipment according to some embodiments.

FIG. 30 is a block diagram of a network node according to some embodiments.

FIG. 31 is a block diagram of a host according to some embodiments.

FIG. 32 is a block diagram of a virtualization environment according to some embodiments.

FIG. 33 is a block diagram of a host communicating via a network node with a UE over a partially wireless connection in accordance with some embodiments.

### DETAILED DESCRIPTION

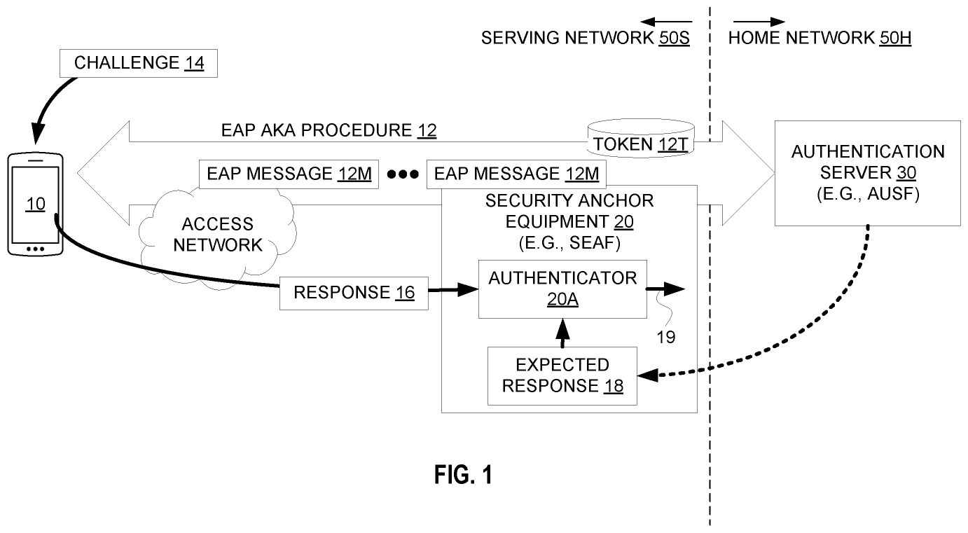

FIG. 1 shows authentication of a communication device 10 according to some embodiments, e.g., where the communication device 10 is shown as a wireless device such as a user equipment (UE). As shown, the communication device 10 attempts to authenticate itself with an authentication server 30, e.g., in a home network 50H of the communication device 10. The authentication server 30 may for instance implement an authentication server function (AUSF), e.g., in a 5G network. Regardless, FIG. 1 shows that authentication with the home network 50H is attempted via an Extensible Authentication Protocol (EAP) Authentication and Key Agreement (AKA) procedure 12 between the communication device 10 and the authentication server 30, e.g., as described in RFC4187 and/or RFC5448. The authentication server 30 may thereby operate as an EAP server for the EAP AKA procedure 12.

Security anchor equipment 20 facilitates the EAP AKA procedure 12 by relaying EAP messages 12M between the communication device 10 and the authentication server 30. In some embodiments, security anchor equipment 20 may be in a serving network 50S of the communication device 10, e.g., which may be different than the home network 50H when the communication device 10 is roaming. Regardless, the security anchor equipment 20 may relay the EAP messages 12M by simply transparently forwarding the EAP messages 12M, without inspecting or modifying the EAP messages 12M. In other embodiments, though, the security anchor equipment 20 may inspect and/or modify the EAP messages 12M before relaying the EAP messages 12M.

According to some embodiments herein, security anchor equipment 20 not only relays EAP messages 12M between the communication device 10 and the authentication server 30, but also itself authenticates the communication device 10. As shown for example, the communication device 10 receives a challenge 14, e.g., from the security anchor equipment 20. The challenge 14 comprises data that is to provoke a different response each time. The challenge 14 may for example be a random token, e.g., which due to its randomness provokes a different response each time. In any event, the communication device 10 correspondingly generates a response 16 to the challenge 14, and transmits the response to the security anchor equipment 20, as part of an attempt to authenticate the communication device 10 to the security anchor equipment 20.

Security anchor equipment 20 checks whether this response 16 corresponds to an expected response 18 as part of an attempt by the security anchor equipment 20 to authenticate the communication device 10. FIG. 1 shows for instance that the security anchor equipment 20 includes an authenticator 20A that obtains both the response 16 and the expected response 18, checks whether the response 16 corresponds to the expected response 18, and produces a decision 19 about whether to authenticate the communication device 10 or to reject the communication device 10.

With the security anchor equipment located in the communication device's serving network 50S, some embodiments effectively enable the serving network 50S to authenticate the communication device 10 even in a context where EAP is used to authenticate the communication device 10 to the home network 50H. In fact, in some embodiments, rather than just naively relay EAP messages between the communication device 10 and the authentication server 30, the security anchor equipment 20 may reject the communication device's attempt to authenticate with the home network 50H if the communication device's attempt to authenticate with the serving network 50S fails, e.g., by dropping or otherwise rejecting an EAP AKA message that the communication device 10 transmits to the authentication server 30 with an authentication response. The security anchor equipment 20 in doing so may advantageously protect the authentication server 30 from overload and/or denial of service attacks.

In some embodiments, the security anchor equipment 20 piggybacks on or otherwise exploits the EAP AKA procedure 12 between the communication device 10 and the authentication server 30 as a basis on which to authenticate the communication device 10 itself. For example, in some embodiments, at least one of the response 16, the challenge 14, and the expected response 18 is, or is derived using, information used in the EAP AKA procedure 12 between the communication device 10 and the authentication server 30.

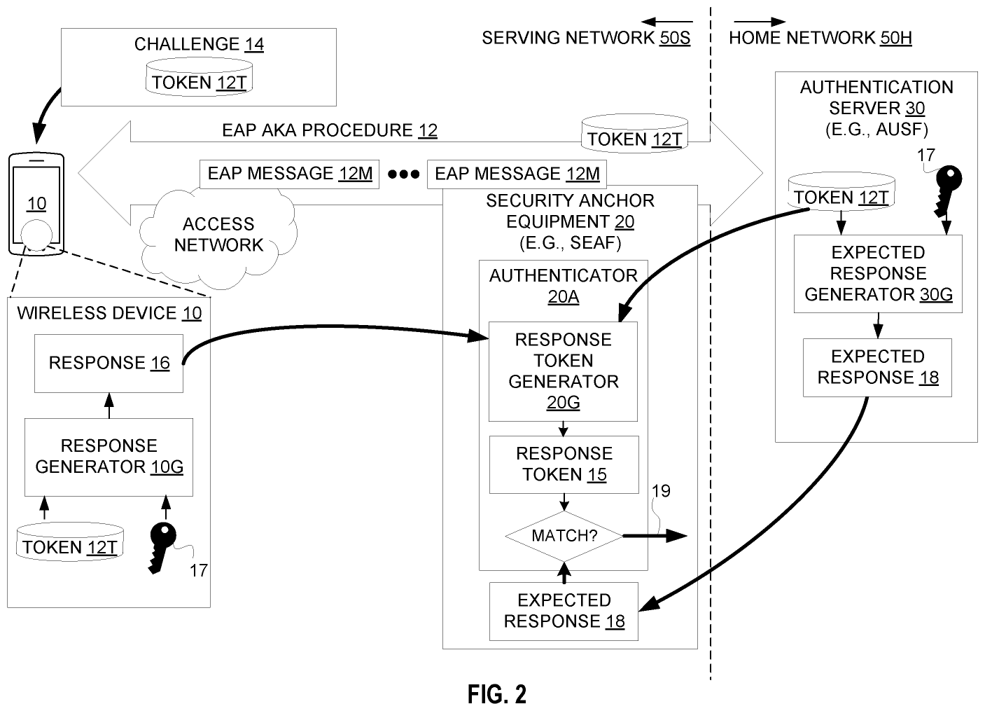

In some embodiments, information used in the EAP AKA procedure 12 between the communication device 10 and the authentication server 30 includes a random token RAND 12T, e.g., as generated by the authentication server 30. In one such embodiment, at least one of the response 16, the challenge 14, and the expected response 18 is, or is derived using, this random token RAND 12T. FIG. 2 shows one example.

As shown in FIG. 2, the challenge 14 that the wireless device 10 receives is the random token 12T used in the EAP AKA procedure 12. In fact, the wireless device 10 may receive the random token 12T as part of, or during, the EAP AKA procedure 12. The wireless device 10 correspondingly derives the response 16 using the random token 12T, e.g., via a response generator 10G. In some embodiments, the wireless device 10 may derive the response 16 also using a cryptographic key 17, e.g., which may be shared between, or derivable by, both the wireless device 10 and the authentication server 30. In any event, the wireless device 10 transmits the response 16 to the security anchor equipment 20.

The authentication server 30 correspondingly derives the expected response 18 using the token 12T, e.g., via expected response generator 30G. In some embodiments, the authentication server 30 derives the expected response 18 also using the cryptographic key 17. In any event, the authentication server 30 transmits the expected response 18 to the security anchor equipment 20.

Having received the response 16 from the communication device 10 and the expected response 18 from the authentication server 30, the security anchor equipment 20 checks whether the response 18 corresponds to the expected response 18 as part of an attempt by the security anchor equipment 20 to itself authenticate the communication device 10. For example, in some embodiments, the security anchor equipment 20 as shown generates a response token 15 from the response 18 and the random token RAND 12T, e.g., via a response token generator 20G. The security anchor equipment 20 then checks whether the response token 16 is equal to (i.e., matches) the expected response 18. In some embodiments, if the response token 15 is equal to the expected response 18, the security anchor equipment 20 authenticates the communication device 10, whereas if the response token 15 is not equal to the expected response 18, the security anchor equipment 20 rejects the communication device 10.

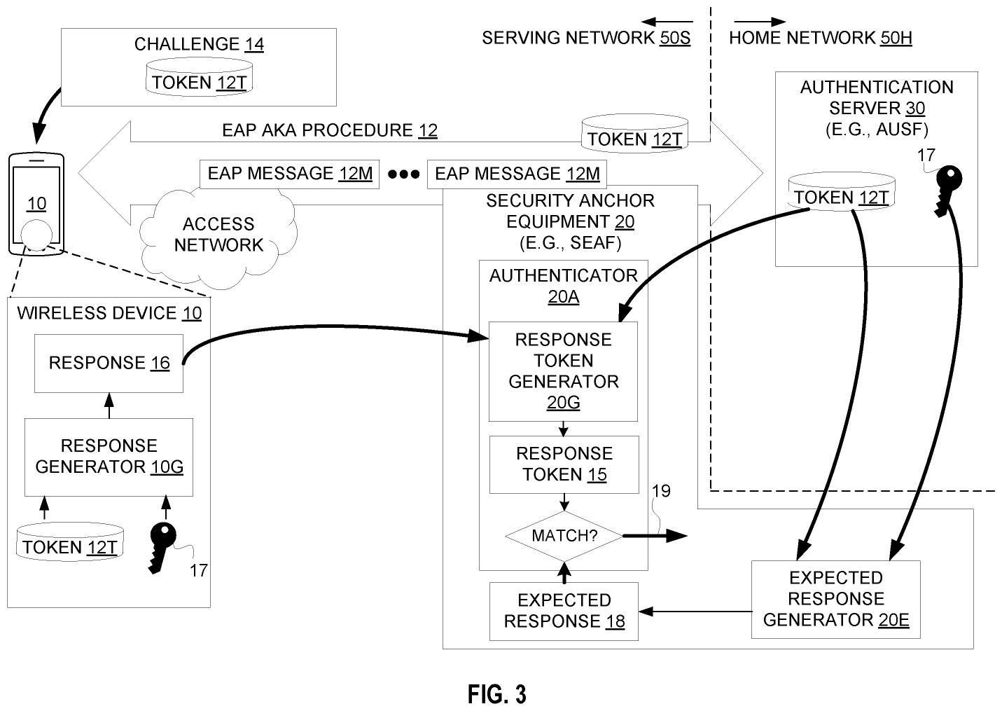

FIG. 3 shows still other embodiments where the security anchor equipment 20, rather than the authentication server 30, derives the expected response 18. As shown, the security anchor equipment 20 receives from the authentication server 30 the random token RAND 12T and (optionally) the cryptographic key 17. The security anchor equipment 20 correspondingly derives the expected response 18 using the random token RAND 12T and (optionally) the cryptographic key 17, e.g., via expected response generator 20E.

Note that the security anchor equipment 20 may receive the expected response 18 and/or the random token RAND 12T in any manner. In one embodiment, the security anchor equipment 20 may receive the random token RAND 12T and/or the expected response 18 within an EAP message. For example, where the random token RAND 12T is included in an EAP message 12M that the security anchor equipment 20 is to relay to the communication device 10, the security anchor equipment 20 may retrieve the random token RAND 12T from that EAP message 12M, e.g., by snooping the random token RAND 12T from the EAP message 12M rather than transparently forwarding the message 12M. In other embodiments, though, the security anchor equipment 20 may receive the expected response 18 and/or the random token RAND 12T in a non-EAP message, e.g., a message that is not an EAP AKA message. In one example, the security anchor equipment 20 may receive the expected response 18 and/or the random token RAND 12T in an Authentication, Authorization, and Accounting, AAA, message or a Serviced-Based Architecture, SBA, data carried in an application layer message.

Similarly, the security anchor equipment 20 may receive the response 16 from the communication device 10 in any manner. For example, where the response 16 is included in an EAP message 12M that the security anchor equipment 20 is to relay to the communication device 10, the security anchor equipment 20 may retrieve the response 16 from that EAP message 12M, e.g., by snooping the response 16 from the EAP message 12M rather than transparently forwarding the message 12M. In other embodiments, though, the security anchor equipment 20 may receive the response 16 in a non-EAP message, e.g., a message that is not an EAP AKA message. In one example, the security anchor equipment 20 may receive the response 16 in a non-access stratum (NAS) message.

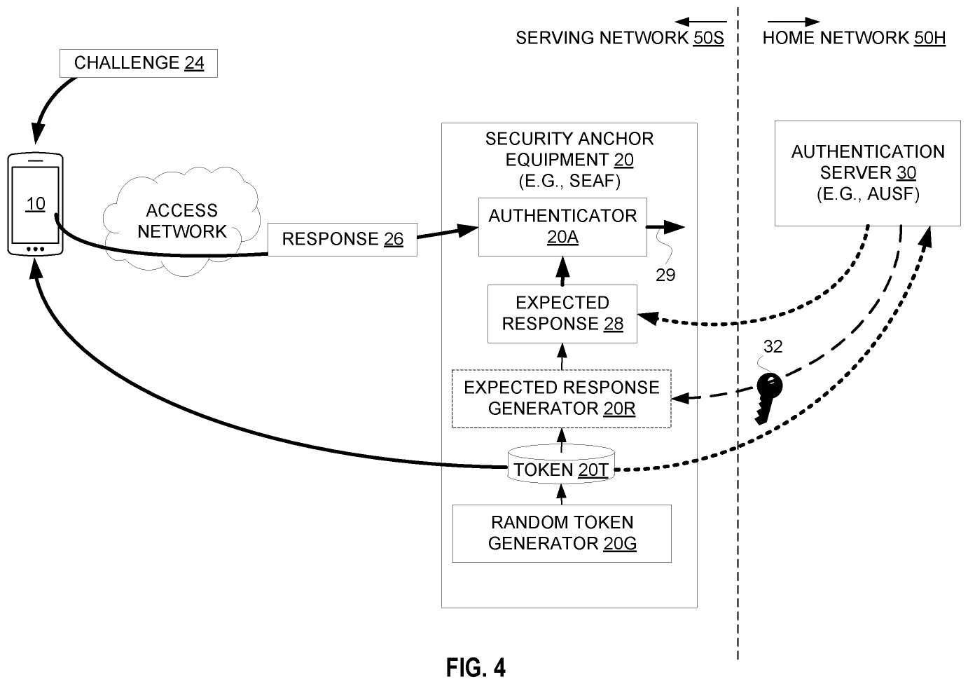

FIG. 4 illustrates authentication of a communication device 10 according to other embodiments herein that may be implemented separately from or in conjunction with embodiments shown in FIG. 1. In these embodiments, the security anchor equipment 20 contributes randomness to authentication of the communication device 10, e.g., authentication of the communication device 10 by the security anchor equipment 20 itself and/or authentication of the communication device 10 by the authentication server 30. Indeed, instead of or in addition to the authentication server 30 generating a random token on which authentication is to be based, the security anchor equipment 20 itself generates a random token on which authentication is to be based.

More particularly, as shown in FIG. 4, the security anchor equipment 20 itself authenticates the communication device 10 on the basis of the communication device's response 26 to a challenge 24. Similar to that described above, the security anchor equipment 20 checks whether the response 26 that the communication device 10 provides to the challenge 24 corresponds to an expected response 28, as part of an attempt by the security anchor equipment 20 to authenticate the communication device 10. Notably, though, the expected response 28 is derived using a random token 20T that the security anchor equipment 20 generates, e.g., via a random token generator 20G. The random token 20T may for example be referred to as a random token RAND*. In some embodiments, the random token 20T is a random number, e.g., with a length of 128 bits. In one embodiment, the random token 20T generated by the security anchor equipment 20 serves as (i.e., is) the challenge 24.

In some embodiments, the security anchor equipment 20 itself derives the expected response 28 using the random token 20T, e.g., via an expected response generator 20R. In other embodiments, the security anchor equipment 20 transmits the random token 20T to the authentication server 30, which in turn derives the expected response 28 using the random token 20T and transmits the expected response 28 to the security anchor equipment 20. Either way, the expected response 28 is derived, either by the security anchor equipment 20 or by the authentication server 30, using the random token 20T that the security anchor equipment 20 generates.

The expected response 28 in one or more embodiments may be derived also using one or more other parameters. For example, in one embodiment, the expected response 28 is derived also using a cryptographic key 32, e.g., that is shared between, or is derivable by both, the communication device 10 and the authentication server 30. In this case, in embodiments where the authentication server 30 derives the expected response, the authentication server 30 does so using the random token 20T received from the security anchor equipment 20 and using the cryptographic key 32 at the authentication server 30. By contrast, in embodiments where the security anchor equipment 20 derives the expected response 28, the authentication server 30 transmits the cryptographic key 32 to the security anchor equipment 20, whereupon the security anchor equipment 20 derives the expected response 28 using the random token 20T generated by the security anchor equipment 20 and using the cryptographic key 32 received from the authentication server 30.

As another example, in one embodiment, the expected response 28 is derived also using a random token 12T generated by the authentication server 30, e.g., as described in FIGS. 1-3.

Regardless, in one or more embodiments, the security anchor equipment 20 transmits the random token 20T to the communication device 10. In this case, the communication device 10 may generate the response 26 using the random token 20T.

In some embodiments, the security anchor equipment 20 checks whether the response 26 that the communication device 10 provides to the challenge 24 corresponds to the expected response 28 by checking whether the response 26 is equal to the expected response 28. In some embodiments, if the response 26 is equal to the expected response 28, the security anchor equipment 20 authenticates the communication device 10, whereas if the response 26 is not equal to the expected response 28, the security anchor equipment 20 rejects the communication device 10.

Note that the security anchor equipment 20 may receive the expected response 28 and/or the cryptographic key 32 in any manner. In one embodiment, the security anchor equipment 20 may receive the expected response 28 and/or the cryptographic key 32 within an EAP message. In other embodiments, though, the security anchor equipment 20 may receive expected response 28 in a non-EAP message, e.g., a message that is not an EAP AKA message. In one example, the security anchor equipment 20 may receive expected response 28 in an Authentication, Authorization, and Accounting, AAA, message or a Serviced-Based Architecture, SBA, data carried in an application layer message.

Similarly, the security anchor equipment 20 may receive the response 26 from the communication device 10 in any manner. For example, the security anchor equipment 20 may receive the response 26 in a non-EAP message, e.g., a message that is not an EAP AKA message. In one example, the security anchor equipment 20 may receive the response 26 in a non-access stratum (NAS) message.

Note though that embodiments illustrated in FIG. 4 are not limited to being performed in an EAP AKA context. For example, the embodiments may be performed as part of, or during, a 5G AKA procedure between the communication device 10 and the authentication server 30. Or, the embodiments may be performed as part of, or during, a an EAP AKA procedure between the communication device 10 and the authentication server 30.

Consider now some concrete examples of the embodiments illustrated above, in a context of a 5G network.

In 5G, there are two alternative methods for authentication: (a) 5G AKA, a further development of 3G and 4G AKA authentication mechanism, and (b) EAP-AKA′, an authentication protocol that supports 3G, 4G, and 5G AKA process. These are described in the following two sections.

### 5G AKA

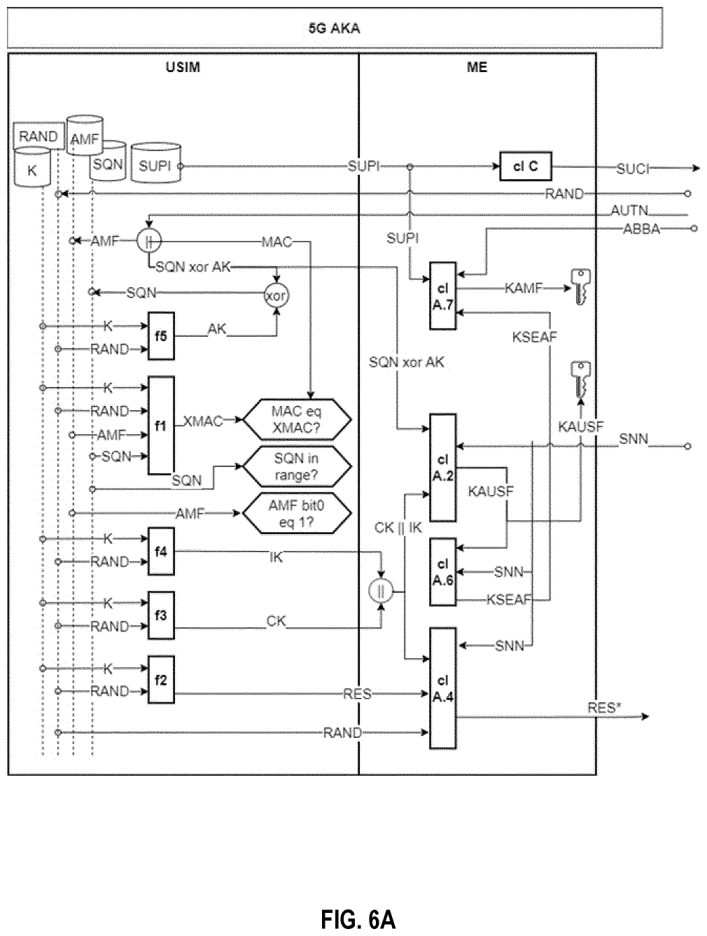

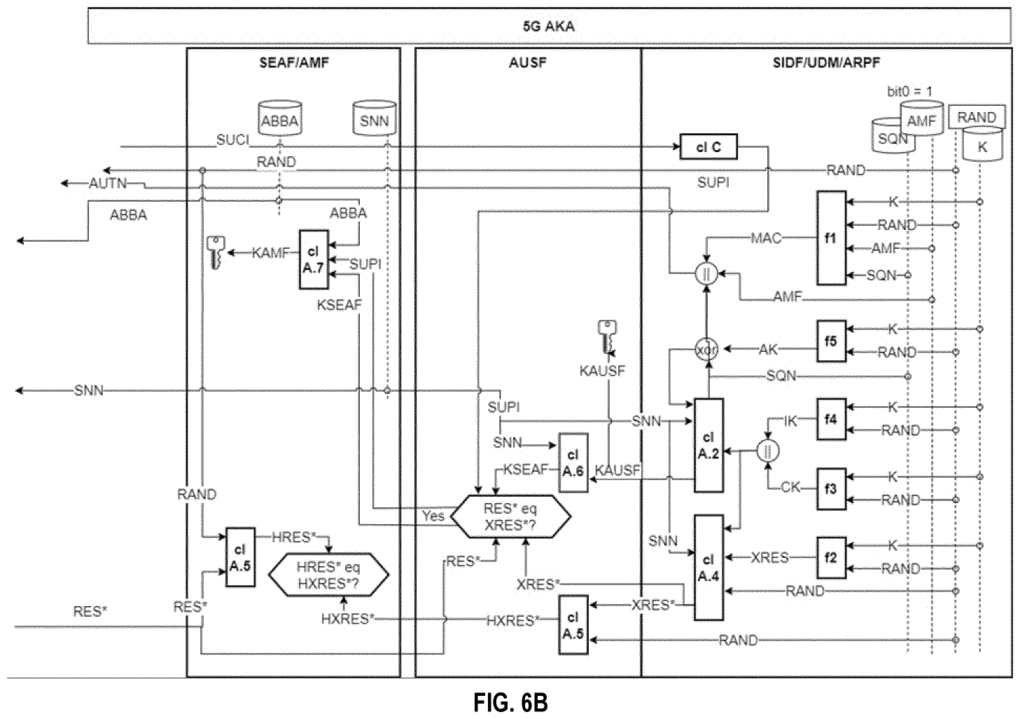

The 5G native authentication, 5G-AKA, follows the same model as with 4G authentication using Universal Subscriber Identity Modules (USIMs) and AKA. However, there are some extensions. 5G AKA as specified heretofore is shown in FIGS. 6A-6B and is described as follows. USIM is used, not Subscriber Identity Module (SIM). Authentication terminates both at roaming and home Core Network (CN). UE identifies itself with Subscription Concealed Identifier (SUCI) which can only be de-concealed by the home CN. The roaming CN authenticates the UE by checking 128-bits HRES* and HXRES*. The home CN authenticates the UE by checking 128-bits RES* and XRES*. The UE authenticates the home CN by checking 64-bits MAC and XMAC and by verifying that 48-bits SQN is within acceptable range. The UE authenticates the roaming CN by binding the variable length Serving Network Name (SNN) to KAUSF, and KSEAF. The SNN is also bound to RES* and XRES*. UE checks service type by verifying that the AMF bit 0 is 1. Service type is also bound to KAUSF, KSEAF, RES*, and XRES* because SNN contains the service code string “5G”. Anti-Bidding down Between Architectures (ABBA) is achieved by binding the ABBA value to KAMF. User identifier binding is achieved by binding SUPI to KAMF. 256-bits KAMF is shared between the UE and the roaming CN. 256-bits KAUSF is shared between the UE and the home CN.

### EAP-AKA′

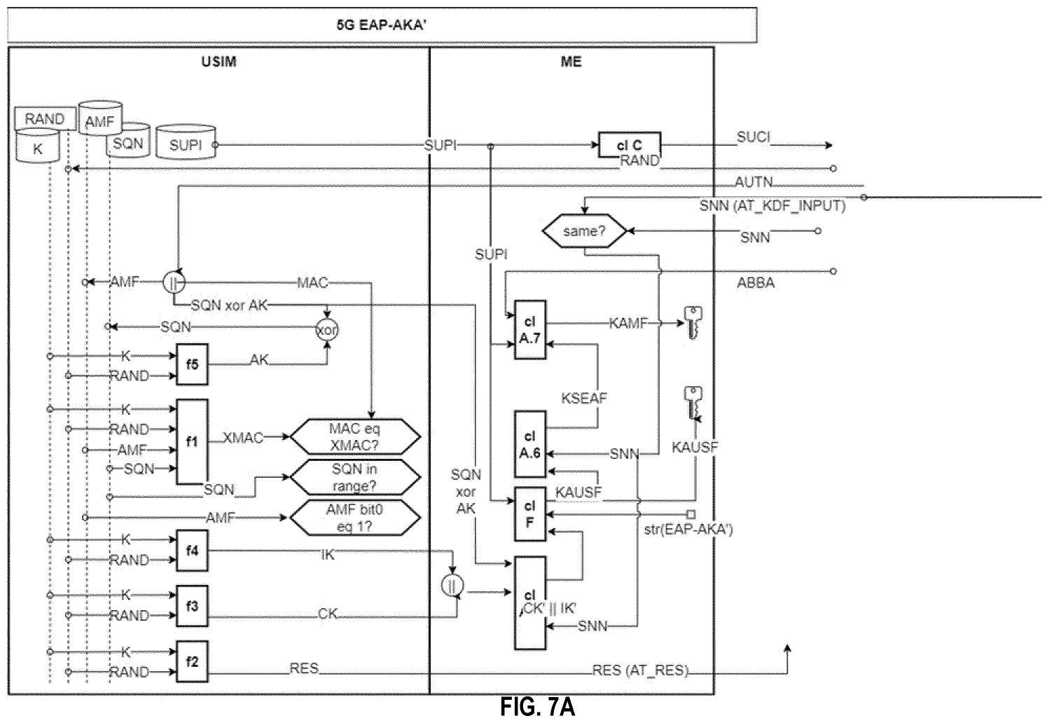

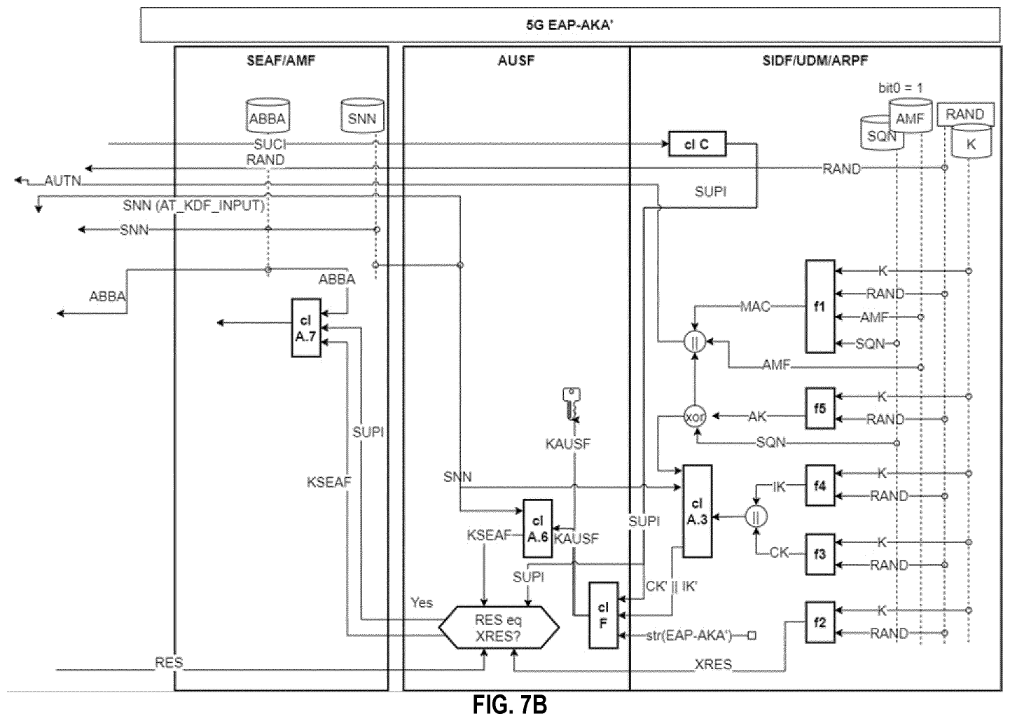

5G EAP-AKA′ authentication as specified heretofore is shown in FIGS. 7A-7B and is described as follows. USIM is used, not SIM. Authentication terminates at home CN. It is based on EAP-AKA′ specified in IETF RFC 5448 which is being updated in Jari Arkko, Vesa Lehtovirta, Vesa Torvinen, and Pasi Eronen. Improved Extensible Authentication Protocol Method for 3GPP Mobile Network Authentication and Key Agreement (EAP-AKA′). Internet-Draft draft-ietf-emu-rfc5448bis-10, Internet Engineering Task Force, May 2021. Work in Progress. UE identifies itself with Subscription Concealed Identifier (SUCI) which can only be de-concealed by the home CN. The home CN authenticates the UE by checking 32- to 128-bits RES and XRES. The UE authenticates the home CN by checking 64-bits MAC and XMAC and by verifying that 48-bits SQN is within acceptable range. The UE authenticates the roaming CN by explicitly checking the SNN sent by the home CN and binding the variable length SNN to CK′∥IK′, KAUSF, and KSEAF. UE checks service type by verifying that the AMF bit 0 is 1. Service type is also bound to CK′∥IK′, KAUSF, and KSEAF because the SNN contains the service code string “5G”. KAUSF (and implicitly KSEAF too) is bound to the authentication method because of “EAP-AKA” input as a string. Anti-Bidding down Between Architectures (ABBA) is achieved by binding the ABBA value to KAMF. User identifier binding is achieved by binding SUPI to KAMF. 256-bits KAMF is shared between the UE and the roaming CN. 256-bits KAUSF is shared between the UE and the home CN.

Accordingly, there are some differences between the different approaches in 5G authentication methods. In addition to using slightly different protocols (native 5G signalling in 5G AKA or a general authentication framework in 5G EAP-AKA′), there are also differences with respect to the security characteristics and capabilities.

In EAP-AKA′, the serving network heretofore does not “explicitly” authenticate the UE. Indeed, in EAP-AKA′, the approach is more end-to-end; the UE responds, and the home network performs all the checking. The serving network is only in the role of passing EAP messages back and forth between the endpoints. The serving network will be told by the home network about the eventual authentication success, but only after the home network has performed the check.

A first problem therefore is that the EAP framework heretofore does not enable the serving network to perform an early and additional authentication check.

A second problem is that the RES*/HXRES* process in 5G AKA may not be the only or the best way to achieve the desired property. In the 5G AKA process, the serving network is still an observer in the protocol and cannot contribute randomness. A second problem is, therefore, that the 5G AKA or EAP-AKA′ does not heretofore provide a mechanism that both (a) allows serving network to authenticate the UE early and (b) provides a way for the serving network to contribute randomness to the authentication process.

Certain aspects of the disclosure and their embodiments may provide solutions to these or other challenges. The above described problems are solved via two related but distinct solutions, described here as embodiments.

The first embodiment provides a way for the serving network to perform an early authentication check of the UE when running EAP-AKA′. The benefits of the check include an ability to check that the response by the UE is correct before the response is forwarded to the home network. This provides a better ability to protect against bogus responses from UEs and some denial-of-service attacks. This also ensures that the capabilities of the EAP-AKA′ authentication model are as good or better than those in 5G-AKA; previously they differed.

The second embodiment provides a way to extend either EAP-AKA′ or 5G-AKA processes for a more comprehensive check than is currently offered by either process.

Specifically, according to the first embodiment, the serving network is able to perform an early check. Alternatively or additionally, accord second embodiment, the serving network is able to contribute to the cryptographic values used by the authentication process, so that it can ensure the process is live from its point of view. The specific cryptographic value used in this second embodiment is randomness. This provides an improved authentication process over the one currently in use in 5G.

The first embodiment (Embodiment 1) is referred to as EAP-AKA′, a new authentication method, embodiments of which are discussed below. This first embodiment exemplifies embodiments shown in FIGS. 1-3.

### Embodiment 1.a-eap: EAP-AKA′ Embodiment-1a

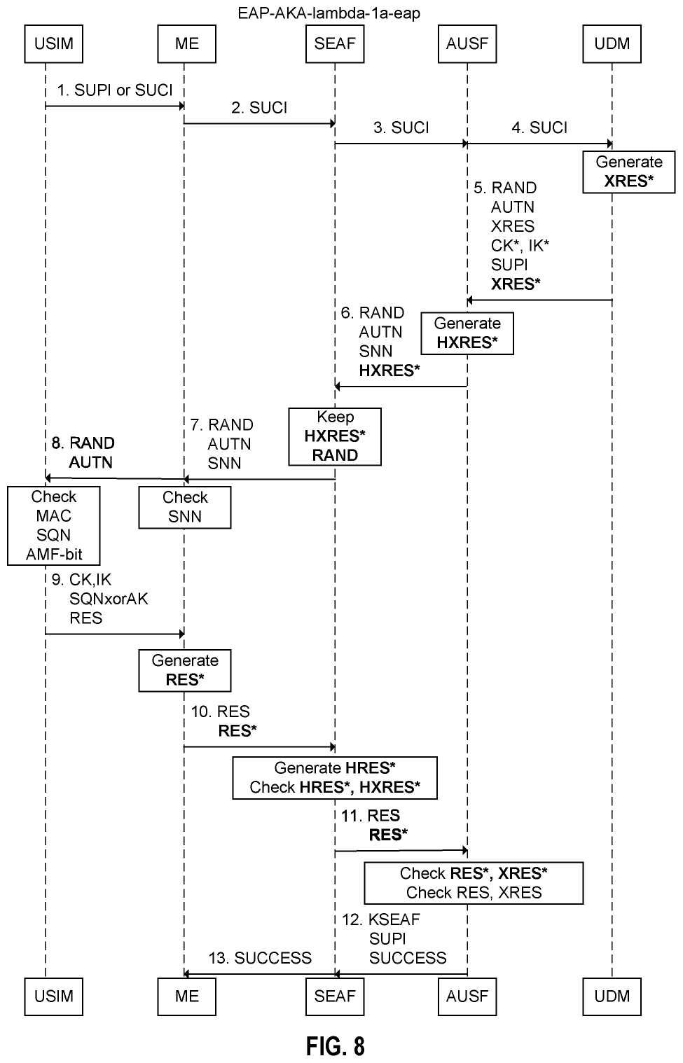

An example flow of this embodiment is shown in FIG. 8. New fields are shown in bold.
1. USIM provides either SUPI or SUCI to ME.
2. ME generates SUCI from SUPI if USIM provided SUPI. ME provides SUCI to SEAF.
3. SEAF provides SUCI to AUSF within an EAP-Identity response message.
4. AUSF terminates EAP protocol and provides SUCI to UDM. UDM generates among other things RAND and XRES*. The XRES* is UDM's value that is based among other things, on the RAND from itself and secret key values shared between the UDM and the USIM.
   NOTE: In Step 4, UDM generates HXRES* even for EAP-AKA′ based authentication.
5. UDM provides XRES* along with RAND, AUTN, XRES, CK′, IK′, and SUPI to AUSF. AUSF generates HXRES* using at least the XRES*.
   NOTE: In Step 5, UDM provides XRES* to AUSF even for EAP-AKA′ based authentication. AUSF generates HRES* even for EAP-AKA′ based authentication.
6. AUSF continues the EAP authentication process and sends an EAP-Request/AKA′-Challenge message that includes RAND and AUTN among other things. AUSF also provides HXRES* along with the EAP message to SEAF.
   NOTE: In Step 6, AUSF provides HXRES* to SEAF. Note that HXRES* and the other values are carried in different protocol layers. HXRES* is carried in an AAA protocol data, e.g., in a Diameter attribute or SBA data carried in HTTP/HTTPS. The rest of the conversation is an EAP protocol run and is carried as a separate message within the AAA protocol, and not understood by the AAA protocol in any fashion.
   NOTE b: In another variant, the AUSF could send the RAND both in the EAP message and separately in an AAA protocol data. Also see NOTE b in Step 7.
7. SEAF keeps HXRES* to itself. SEAF also peeks into the EAP message to verify that it is an EAP-AKA′ message and retrieves the RAND value from the AT_RAND attribute of EAP-AKA′. SEAF provides the rest, i.e., the EAP protocol message to ME.
   NOTE: In Step 7, SEAF keeps HXRES* even in an EAP authentication case. SEAF retrieves RAND from inside EAP message.
   NOTE b: In another variant, instead of SEAF peeking into the EAP message, the SEAF could obtain the RAND separately from the AAA protocol data. Also see NOTE b in Step 6.
8. ME provides RAND and AUTN to USIM. ME checks that SNN is valid. USIM checks that MAC, SQN, and AMF-bit is valid.
9. USIM provides CK, IK, and RES to ME. ME also obtains SQNxorAK. Then, ME generates RES, which is ME's response to the challenge from the UDM. ME also generates RES*, which is derived based on RAND and RES, as in 5G-AKA.
   NOTE: In Step 9, ME generates RES* even for EAP authentication.
   NOTE: In Step 9, ME decides that RES* needs to be generated. It can do this, for instance, based on the EAP method type, which could be set to a new value different from EAP-AKA′.
10. ME provides RES* in an EAP-Response/AKA′-Challenge message in a new attribute, AT_RESSTAR, along with some other EAP-AKA′ related data. SEAF retrieves AT_RESSTAR from inside the EAP message, and checks that this HRES* (calculated from RES* and RAND) matches the HXRES* from Step 6/7.
   NOTE: In Step 10, ME provides RES* inside EAP-AKA′. SEAF checks RES* against HXRES*
   NOTE: In another variant, ME might send the RES* not inside EAP-AKA′ but in a separate attribute of the protocol that connects between the UE and the serving network. In 5G this protocol is the NAS protocol.
11. SEAF provides the EAP message to AUSF that contains RES. AUSF checks that RES from AT_RES and XRES from Step 5 are the same. Additionally, AUSF checks that RES* from AT_RESSTAR and XRES* from Step 5 are the same.
12. AUSF provides KSEAF, SUPI, and SUCCESS to SEAF, along with an EAP-Success message.
13. SEAF provides EAP-Success message to ME.

Here, with respect to FIG. 1, the SEAF exemplifies the security anchor equipment 20, the AUSF exemplifies the authentication server 30, the HXRES* exemplifies the expected response 18, RAND exemplifies the challenge 14 and the random token 12T, and RES* exemplifies the response 16.

### Embodiment 1.b-eap: Variant of EAP-AKA′ Embodiment-1a

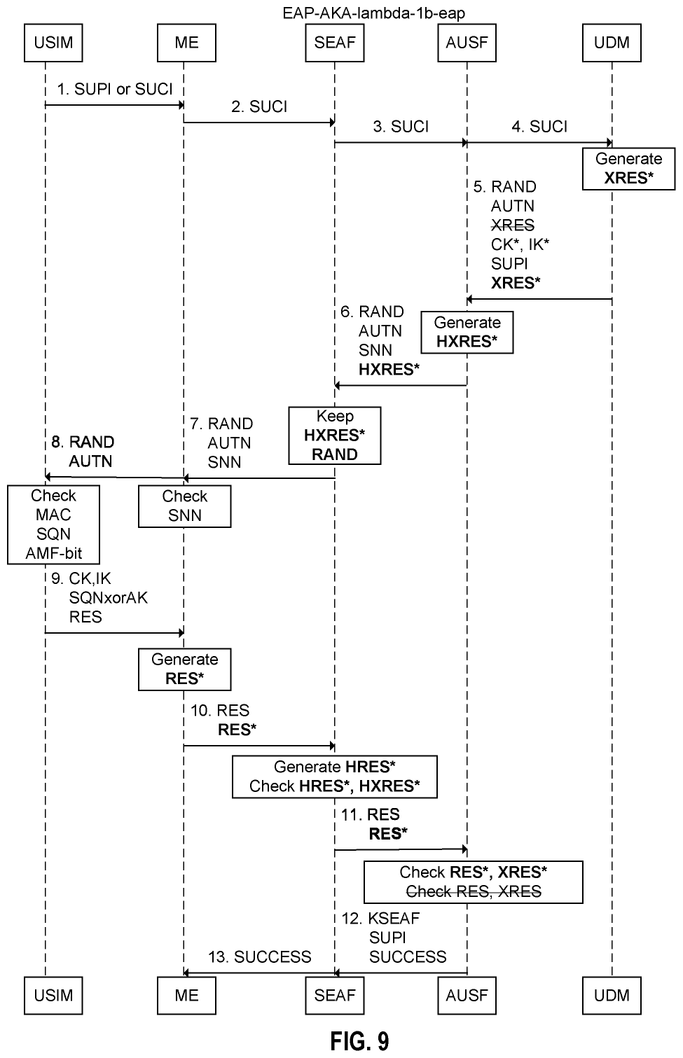

In this variant, only RES* is sent from the UE, instead of sending both RES and RES*. This means that changes are needed in the EAP-AKA′ method. The full sequence of events is given in FIG. 9, but the first change with respect to Embodiment 1.a-eap occurs only in Steps 5, 10, and 11:
1. USIM provides either SUPI or SUCI to ME.
2. ME generates SUCI from SUPI if USIM provided SUPI. ME provides SUCI to SEAF.
3. SEAF provides SUCI to AUSF within an EAP-Identity response message.
4. AUSF terminates EAP protocol and provides SUCI to UDM. UDM generates among other things RAND and XRES*. The XRES* is UDM's value that is based among other things, on the RAND from itself and secret key values shared between the UDM and the USIM.
   NOTE: In Step 4, UDM generates XRES* even for EAP-AKA′ based authentication.
   NOTE: This is exactly as in embodiment 1.a-eap.
5. UDM provides XRES* along with RAND, AUTN, CK′, IK′, and SUPI to AUSF. AUSF generates HRES* using at least the XRES*. Note that UDM does not send XRES to AUSF.
   NOTE: In Step 5, UDM does not send XRES to AUSF.
   NOTE: In Step 5, UDM provides XRES* to AUSF even for EAP-AKA′ based authentication. AUSF generates HRES* even for EAP-AKA′ based authentication.
   NOTE: This is exactly as in embodiment 1.a-eap.
6. AUSF continues the EAP authentication process and sends an EAP-Request/AKA′-Challenge message that includes RAND and AUTN among other things. AUSF also provides HXRES* along with the EAP message to SEAF.
   NOTE: In Step 6, AUSF provides HXRES* to SEAF. Note that HXRES* and the other values are carried in different protocol layers. HXRES* is carried in an AAA protocol data, e.g., in a Diameter attribute or SBA data carried in HTTP/HTTPS. The rest of the conversation is an EAP protocol run, and is carried as a separate message within the AAA protocol, and not understood by the AAA protocol in any fashion.
   NOTE b: In another variant, the AUSF could send the RAND both in the EAP message and separately in an AAA protocol data. Also see NOTE b in Step 7.
   NOTE: This is exactly as in embodiment 1.a-eap.
7. SEAF keeps HXRES* to itself. SEAF also peeks into the EAP message to verify that it is an EAP-AKA′ message and retrieves the RAND value from the AT_RAND attribute of EAP-AKA′. SEAF provides the rest, i.e., the EAP protocol message to ME.
   NOTE: In Step 7, SEAF keeps HXRES* even in an EAP authentication case. SEAF retrieves RAND from inside EAP message.
   NOTE b: In another variant, instead of SEAF peeking into the EAP message, the SEAF could obtain the RAND separately from the AAA protocol data. Also see NOTE b in Step 6.
   NOTE: This is exactly as in embodiment 1.a-eap.
8. ME provides RAND and AUTN to USIM. ME checks that SNN is valid. USIM checks that MAC, SQN, and AMF-bit is valid.
9. USIM provides CK, IK, and RES to ME. ME also obtains SQNxorAK. Then, ME generates RES, which is ME's response to the challenge from the UDM. ME also generates RES*, which is derived based on RAND and RES, as in 5G-AKA.
   NOTE: In Step 9, ME generates RES* even for EAP authentication.
   NOTE: In Step 9, ME decides that RES* needs to be generated. It can do this, for instance, based on the EAP method type, which could be set to a new value different from EAP-AKA′.
   NOTE: This is exactly as in embodiment 1.a-eap.
10. ME provides RES* in an EAP-Response/AKA′-Challenge message in a new attribute, AT_RESSTAR, along with some other EAP-AKA′ related data. AT_RES is not carried, in contrast to traditional EAP-AKA′. SEAF retrieves AT_RESSTAR from inside the EAP message, and checks that this HRES* (calculated from RES* and RAND) matches the HXRES* from Step 6/7.
   NOTE: In Step 10, ME does not send RES to SEAF, i.e., RES is not carried in EAP.
   NOTE: In Step 10, ME provides RES* inside EAP-AKA′. This is also new with respect to embodiment 1.a-eap. SEAF checks HRES* against HXRES*.
11. SEAF provides the EAP message to AUSF that contains RES* in the AT_RESSTAR attribute. AUSF checks that RES* from AT_RESSTAR and XRES* from Step 5 are the same.
   NOTE: In Step 11, checking for RES* from AT_RESSTAR is different to currently specified EAP-AKA′ process, which uses RES.
12. AUSF provides KSEAF, SUPI, and SUCCESS to SEAF, along with an EAP-Success message. AUSF checks RES* from AT_RESSTAR to be the same as XRES* from Step 5.
   NOTE: This is different from EAP-AKA′ where only RES is checked. In this embodiment, XRES and RES are not checked.
13. SEAF provides EAP-Success message to ME.

Here, with respect to FIG. 1, the SEAF exemplifies the security anchor equipment 20, the AUSF exemplifies the authentication server 30, the HXRES* exemplifies the expected response 18, RAND exemplifies the challenge 14 and the random token 12T, and RES* exemplifies the response 16.

Embodiment 1 notably enables the serving network to validate the UE's result before the result message even reaches the home network, even in an EAP AKA context. The home network in particular sends a HXRES* value to the serving network and the serving network can validate the UE's RES* value by applying a one-way function to RES* and RAND value and compare result to the expected result (HXRES*). This means that the serving network can validate that the UE responded correctly, even before the serving network sends a message to the home network and even in an EAP AKA context. This gives two nice properties: (a) any incorrect response from UE can be filtered early at the serving network and home network could be protected against message overload or DOS attack, (b) the serving network can itself authenticate the UE without having to wait and solely rely on home network's verdict later. In addition, the serving network can do this without being told what the correct response (RES*) is. This enables the home network to ensure that the serving network did not fabricate the response.

Consider now other embodiments. The EAP-AKA embodiments exemplify the embodiments described in FIGS. 1-3. Both the EAP-AKA embodiments and the 5G AKA embodiments exemplify the embodiments described in FIG. 4. Accordingly, the EAP-AKA embodiments exemplify a combination of the embodiments in FIGS. 1-3 and the embodiments in FIG. 4.

### Embodiment 2.a-eap: EAP-AKA′ Embodiment-2a (SEAF Sending RAND* to AUSF and UE)

In this embodiment, the serving network authenticates the UE by sending a separate challenge to the UE via the home network and comparing their responses.

### Example Flow

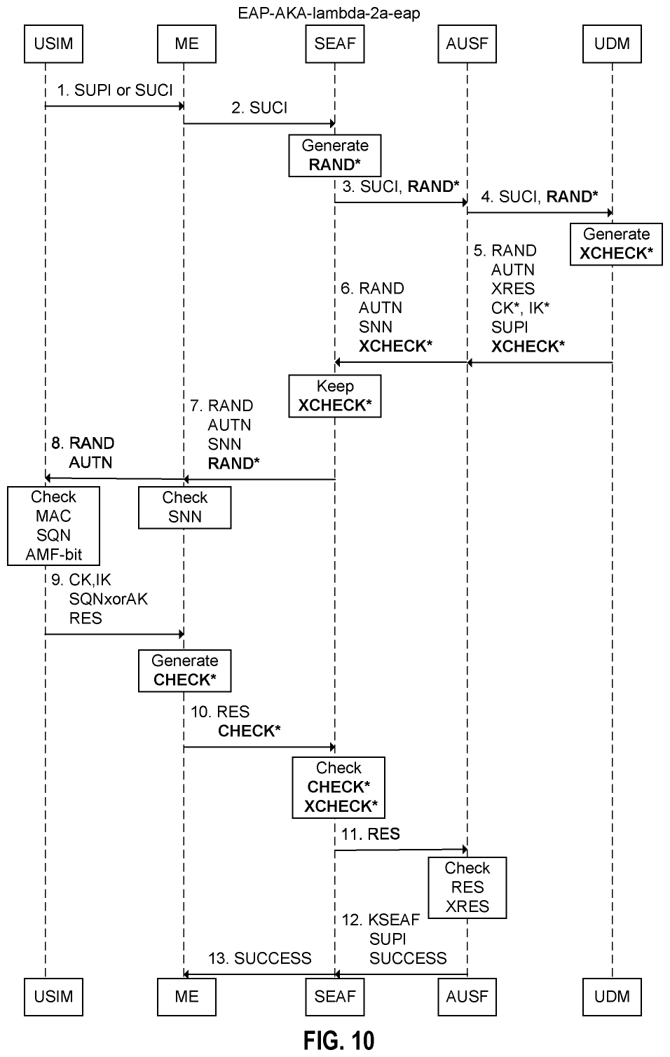

An example message flow is shown in FIG. 10. New fields are shown in bold.

The steps are:
1. USIM provides either SUPI or SUCI to ME.
2. ME generates SUCI from SUPI if USIM provided SUPI. ME provides SUCI to SEAF. SEAF generates a random token RAND*.
   NOTE: In Step 2, SEAF generates RAND*.
3. SEAF provides SUCI and RAND* to AUSF. By this RAND*, SEAF is providing randomness.
   NOTE: In Step 3, SEAF provides RAND* to AUSF.
4. AUSF provides SUCI and RAND* to UDM. UDM generates XCHECK*, which is UDM's value that is based among other things, on the RAND* value from SEAF.
   NOTE: In Step 4, AUSF provides RAND* to UDM. UDM generates XCHECK*.
5. UDM provides XCHECK* along with RAND, AUTN, XRES, CK′, IK′, and SUPI to AUSF.
   NOTE: In Step 5, that UDM provides XCHECK* to AUSF.
6. AUSF provides XCHECK* along with RAND, AUTN, and SNN to SEAF.
   NOTE: In Step 6, AUSF provides XCHECK* to SEAF.
7. SEAF keeps XCHECK* to itself. SEAF provides RAND, AUTN, SNN, and RAND* to ME. This RAND* is the same token that SEAF provided to AUSF in Step 3. This RAND* is a challenge from SEAF to ME.
   NOTE: In Step 7, SEAF keeps XCHECK*. SEAF provides RAND* to ME.
8. ME provides RAND and AUTN to USIM. ME checks that SNN is valid. USIM checks that MAC, SQN, and AMF-bit is valid.
9. USIM provides CK, IK, and RES to ME. ME obtains SQNxorAK. Then, ME generates CHECK*, which is ME's response to the challenge from SEAF.
   NOTE: In Step 9, ME generates CHECK*.
10. ME provides RES and CHECK* to SEAF. SEAF checks that this CHECK* and the XCHECK* from Step 6/7 are the same.
   NOTE: In Step 10, ME provides CHECK* to SEAF. SEAF checks CHECK* and XCHECK*
11. SEAF provides RES to AUSF. AUSF checks that this RES and XRES from Step 5 are the same.
12. AUSF provides KSEAF, SUPI, and SUCCESS to SEAF.
13. SEAF provides SUCCESS to ME.

Here, with respect to FIG. 1, the SEAF exemplifies the security anchor equipment 20, the AUSF exemplifies the authentication server 30, the XCHECK* exemplifies the expected response 18, RAND* exemplifies the challenge 14, and CHECK* exemplifies the response 16. And, with respect to FIG. 4, the SEAF exemplifies the security anchor equipment 20, the AUSF exemplifies the authentication server 30, the XCHECK* exemplifies the expected response 28, RAND* exemplifies the challenge 24 and the random token 20T, and CHECK* exemplifies the response 26.

In an alternative embodiment, the AUSF does not send RAND* in step 4 and UDM does not generate XCHECK* nor send it to AUSF in step 5. Instead, the AUSF generates XCHECK* in step 6.

### XCHECK* and CHECK* Generation

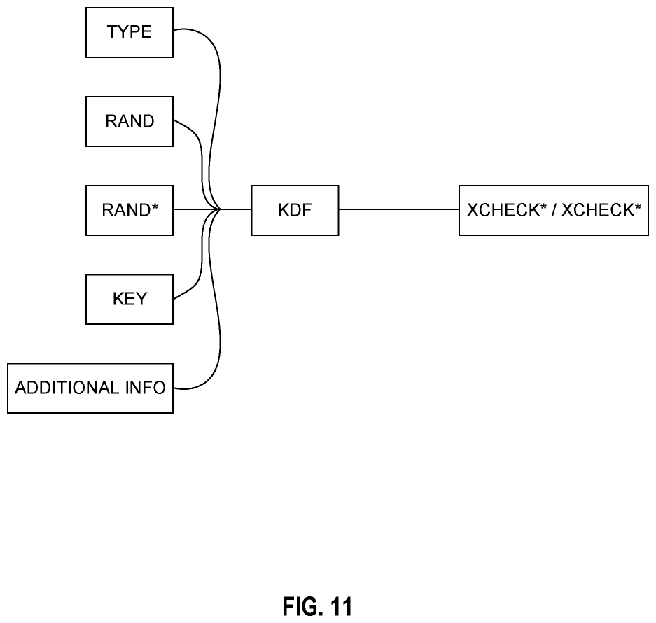

UDM generates XCHECK*. ME generates CHECK*. Calculations of both are as below and as shown in FIG. 11 in some embodiments.
Input: TYPE (like a string “EAP-AKA”), RAND, RAND*, KEY (like K, CK, IK, CK′, IK′, AK), ADDITIONAL_INFO (like a string “5G” or current date-time, serving network name).
KDF: Key derivation function like HMAC-SHA-256
Output: XCHECK or XCHECK* (or truncation of the output)

### Embodiment 2.a-aka: Enhanced 5G-AKA with Similar Mechanisms of 2.a-eap

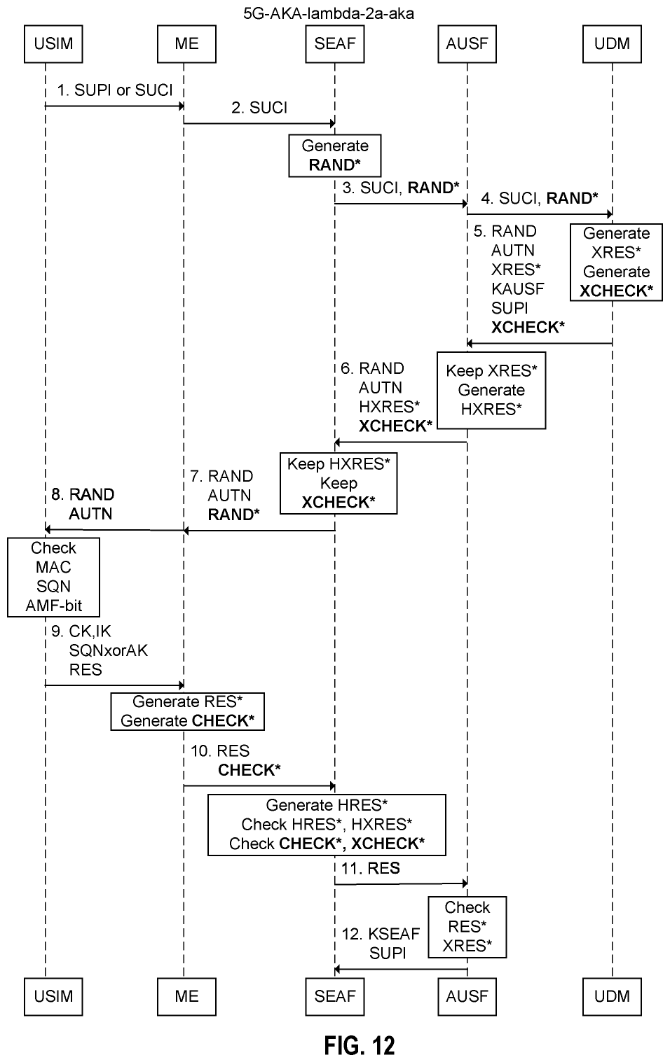

This embodiment uses similar mechanism as 2.a-eap, but as applied to 5G-AKA. An example message flow is shown in FIG. 12.

In this embodiment, both the (CHECK*, XCHECK*) pair and the (RES*, XRES*) pair are used.

Here, with respect to FIG. 4, the SEAF exemplifies the security anchor equipment 20, the AUSF exemplifies the authentication server 30, the XCHECK* exemplifies the expected response 28, RAND* exemplifies the challenge 24 and the random token 20T, and CHECK* exemplifies the response 26.

It should be appreciated that (RES*, XRES*) pair could satisfy the intention of (CHECK*, XCHECK*) pair, for example, by updating the derivation mechanism of RES*, XRES* to include at least the RAND* or the Inputs mentioned earlier for CHECK*, XCHECK*.

### Embodiment 2.b-eap: Variant of EAP-AKA′ Embodiment-2.a-eap (Home Network Sending Keying Material to SEAF so that SEAF Sends RAND* Only to UE)

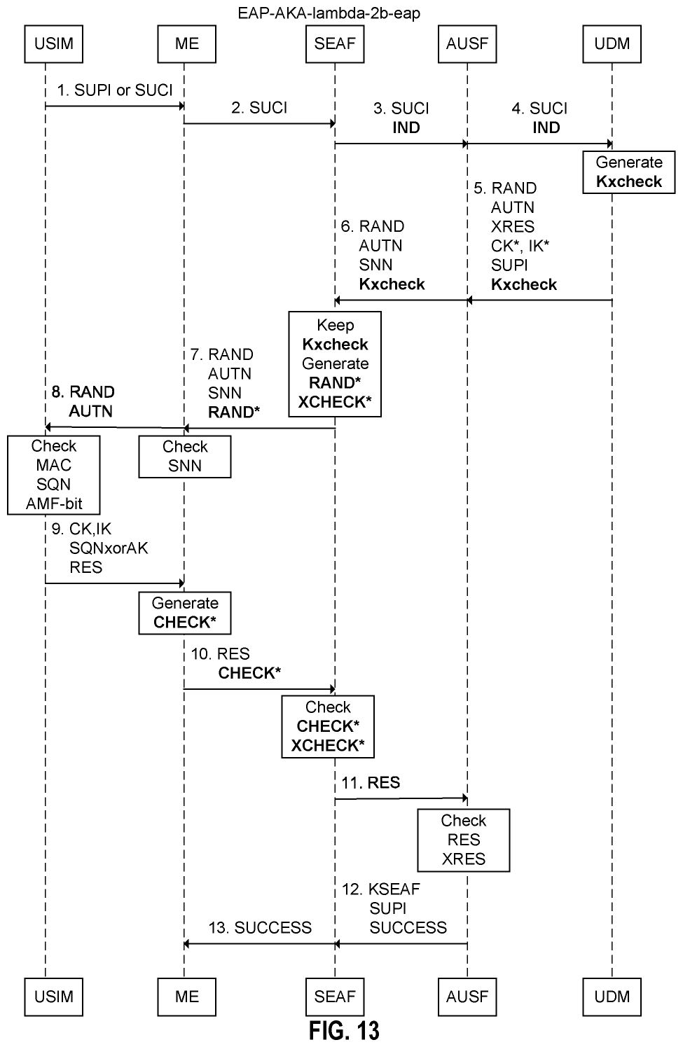

Alternatively, to embodiment 2 where the UDM generates the XCHECK*, the home network could give some keying material to SEAF so that the SEAF sends RAND* directly to UE and the SEAF generates the XCHECK* based on the key material received from home network. This is shown in FIG. 13 and described in the following.

The steps are:
1. USIM provides either SUPI or SUCI to ME.
2. ME generates SUCI from SUPI if USIM provided SUPI. ME provides SUCI to SEAF.
3. SEAF provides SUCI to AUSF. SEAF may provide also an indication IND to AUSF that SEAF needs key material for XCHECK*.
   NOTE: In Step 3, SEAF provides also an indication to AUSF that SEAF needs key material for XCHECK*.
4. AUSF provides SUCI to UDM. AUSF may provide the indication IND to UDM that SEAF needs key material for XCHECK*.
   NOTE: In Step 4, AUSF provides an indication to UDM that SEAF needs key material for XCHECK*.
5. UDM provides RAND, AUTN, XRES, CK′, IK′, and SUPI to AUSF. UDM also generates Kxcheck and provides it to AUSF.
   NOTE: In Step 5, UDM also generates Kxcheck and provides it to AUSF.
6. AUSF provides Kxcheck along with RAND, AUTN, and SNN to SEAF.
   NOTE: In Step 6, AUSF provides Kxcheck to SEAF.
7. SEAF keeps Kxcheck to itself and generates a random token RAND* and also generates XCHECK* which is the expected response to RAND*. SEAF provides RAND, AUTN, SNN, and RAND* to ME. This RAND* is a challenge from SEAF to ME.
   NOTE: In Step 7, SEAF keeps Kxcheck and generates a random token RAND* and XCHECK*. SEAF provides RAND* to ME.
8. ME provides RAND and AUTN to USIM. ME checks that SNN is valid. USIM checks that MAC, SQN, and AMF-bit is valid.
9. USIM provides CK, IK, SQNxorAK, and RES to ME. ME generates CHECK*, which is ME's response to the challenge from SEAF.
   NOTE: In Step 9, ME generates CHECK*.
10. ME provides RES and CHECK* to SEAF. SEAF checks that this CHECK* and the XCHECK* from Step 6/7 are the same.
   NOTE: In Step 10, ME provides CHECK* to SEAF. SEAF checks CHECK* and XCHECK*
11. SEAF provides RES to AUSF. AUSF checks that this RES and XRES from Step 5 are the same.
12. AUSF provides KSEAF, SUPI, and SUCCESS to SEAF.
13. SEAF provides SUCCESS to ME.

In an alternative embodiment, the AUSF generates Kxcheck or derives the Kxcheck from CK′/IK′ in step 6.

### Kxcheck, XCHECK* and CHECK* Generation

XCHECK* and CHECK* generation can be same as in Embodiment 2.

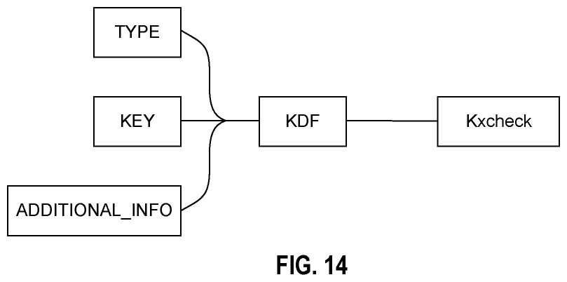

Kxcheck can be derived as below: UDM and ME/USIM generate Kxcheck. Calculations of both are shown in FIG. 14 and are shown below.
Input: TYPE (like a string “EAP-AKA” or a string “Kxcheck”), KEY (like K, CK, IK, CK′, IK′, AK), ADDITIONAL_INFO (like a string “5G” or current date-time, serving network name).
KDF: Key derivation function like HMAC-SHA-256
Output: Kxcheck (or truncation of the output)

Here, with respect to FIG. 1, the SEAF exemplifies the security anchor equipment 20, the AUSF exemplifies the authentication server 30, the XCHECK* exemplifies the expected response 18, RAND* exemplifies the challenge 14, and CHECK* exemplifies the response 16. And, with respect to FIG. 4, the SEAF exemplifies the security anchor equipment 20, the AUSF exemplifies the authentication server 30, the XCHECK* exemplifies the expected response 28, RAND* exemplifies the challenge 24 and the random token 20T, Kxcheck exemplifies the cryptographic key 32, and CHECK* exemplifies the response 26.

### Embodiment 2.b-aka: Enhanced 5G-AKA with Similar Mechanisms of 2.b-eap

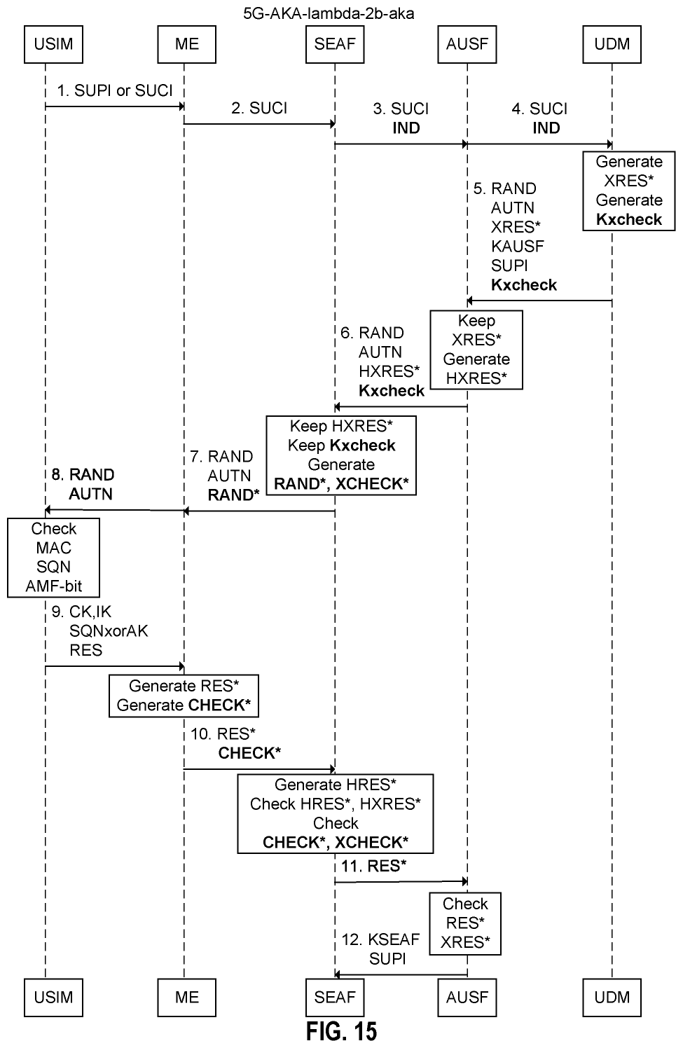

This embodiment uses similar mechanism as 2.b-eap, but as applied to 5G-AKA. An example message flow is shown in FIG. 15.

In this embodiment, both the (CHECK*, XCHECK*) pair and the (RES*, XRES*) pair are used.

Here, with respect to FIG. 4, the SEAF exemplifies the security anchor equipment 20, the AUSF exemplifies the authentication server 30, the XCHECK* exemplifies the expected response 28, RAND* exemplifies the challenge 24 and the random token 20T, Kxcheck exemplifies the cryptographic key 32, and CHECK* exemplifies the response 26.

It should be appreciated that (RES*, XRES*) pair could satisfy the intention of (CHECK*, XCHECK*) pair, for example, by updating the derivation mechanism of RES*, XRES* to include at least the RAND* or the Inputs mentioned earlier for CHECK*, XCHECK*.

### Encoding the Carried Additional Information in EAP, AAA, and NAS Protocols

Some embodiments require the passing of at least some of the following information:
a) The RAND*, IND value from the serving network (SEAF) to the home network (AUSF/UDM).
b) The XCHECK*, Kxcheck value from the home network to the serving network.
c) The RAND* value from the serving network the terminal (ME).
d) The CHECK*, RES* value from the terminal (ME) to the serving network.

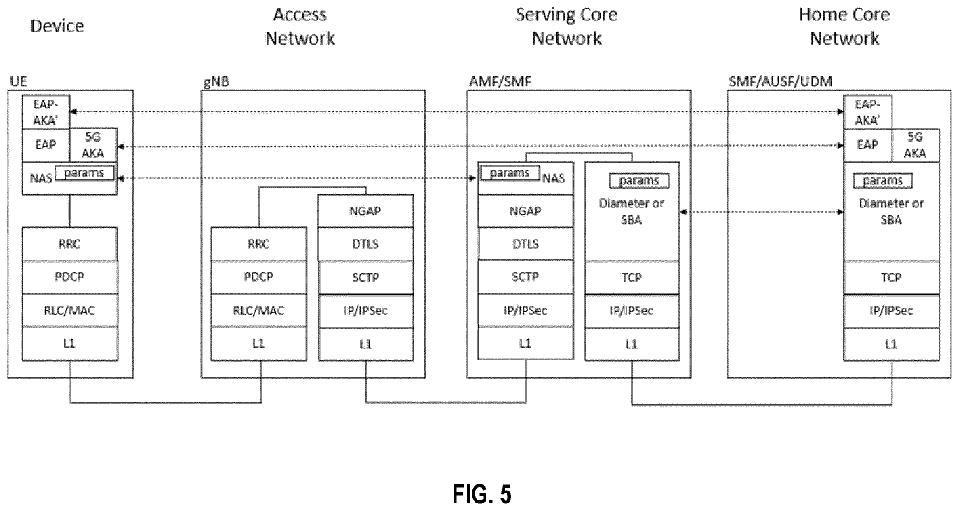

This can be done in many suitable manner. At least some options for which are listed below, with the relevant protocols being stacked as illustrated in FIG. 5:

Option 1: A value may be added to the AAA protocol such as DIAMETER that carries the EAP packets. This is the typical procedure for any information that needs to be passed in the network. A suitable AAA protocol attribute-value pair would be used to carry the information. This could be done for the cases “a” and “b” above.

Option 2: A value may be added to the lower layer protocols that operate between the terminal and the network. AAA protocols are typically not run in this interface. But protocols such as the 5G NAS protocol or the security setup commands can be used to pass extra information. Such extra information would be an extension of these protocols, and the information would typically be carried in attribute-value pairs. For instance, the serving network might send the RAND* value to the terminal and the terminal might send the CHECK* value back to the serving network (cases “c” and “d” from above). Both values would be carried inside the lower layer protocols used for establishing connectivity to the terminal. For instance, the NAS protocol could be modified to support this additional information.

Option 3: A value sent within an EAP method packets may be snooped by intermediate nodes, even if it is not a direct participant in the conversation. In order for this to be successful, the value needs to be available in cleartext in the EAP method packet, and the intermediate node needs to understand that. For instance, the serving network might send the RAND* value to the terminal, and the terminal might send the CHECK value back to the serving network (cases “c” and “d” from above). Both would be carried inside the EAP-AKA′ method packets.

Option 4: A value may be added to an EAP method packet by an intermediate node, again even if it is not a direct participant. In order for this to be successful, the value cannot be part of any integrity checks, and generally needs to be removed before the final recipient of the message processes it. This could be done, for instance, with the CHECK* values from the terminal to the serving network (case “d” from above).

Option 5: A redesigned authentication protocol, “EAP++” could operate as a three-party protocol where the authenticator (the serving network) is a full participant in the exchange, and can send information, e.g., in attribute-value pairs to the home network (case “a” from above). It can also receive information from other participants, e.g., case “b” from above.

Consider now embodiments addressing how the UE can know that it has to do something different. In some embodiments, the UE needs to receive an indication from the network so that the UE knows to act according to the new functionality in the embodiment. In all variants of embodiment 2, the UE receives RAND* from the network which serves as the indication. In all variants of embodiment 1, the RAND* is not sent to the UE from the network. Therefore, another network needs to send another kind of indication to the UE so that the UE knows to act according to the embodiment. If the embodiment is impacting the EAP functionality, then the EAP method type field (i.e., a new type value) can serve as the indication. In embodiments not impacting the EAP functionality, the network may send an indication outside of EAP to the UE.

Generally, then, the above concrete examples may be described as follows. Embodiment 1 focuses on solving problem 1 and comes in two further variants.

Embodiment 1.a-eap: Applies to EAP. In addition to the traditional EAP-AKA′ parameters, the home network generates HXRES* and sends that to the serving network instead of XRES. The UE sends two responses RES and RES* to the serving network. This enables the serving network to check whether the UE sends the correct RES* value, thereby authenticating the UE.

Embodiment 1.b-eap: Applies to EAP. The UE sends only one response value to the serving network.

Embodiment 2 solves both problems 1 and 2. It comes in three further variants. This embodiment extends the traditional EAP-AKA′ and 5G-AKA authentication processes.

Embodiment 2.a-eap: Applies to EAP. The serving network generates RAND* which is sent to the home network which in turn generates XCHECK* and sends that to the serving network. The serving network sends RAND* also to the UE along with the traditional EAP-AKA′ authentication parameters. This enables the serving network to authenticate the UE.

Embodiment 2.a-aka: Applies to AKA. The same arrangements as 2.a-eap performed as an extension of the 5G-AKA process.

Embodiment 2.b-eap: Applies to EAP. The serving network gets key material from the home network so that it can itself generate the XCHECK*.

Embodiment 2.b-aka: Applies to AKA. The same arrangements as 2.b-eap are performed as an extension of the 5G-AKA process.

Embodiments 1 and 2 can further use different protocol attributes to carry information, leading to further minor variants discussed here.

Steps of the various networks/nodes for Embodiments 1 and 2 may be exemplified as follows.

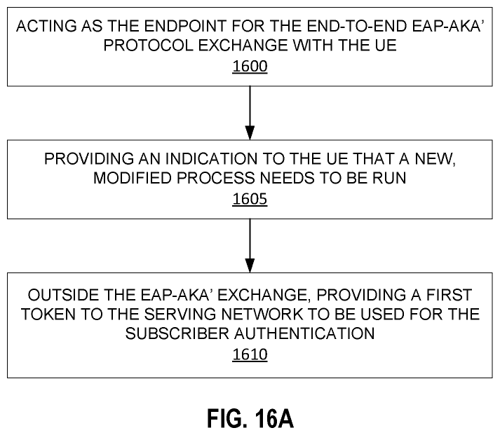

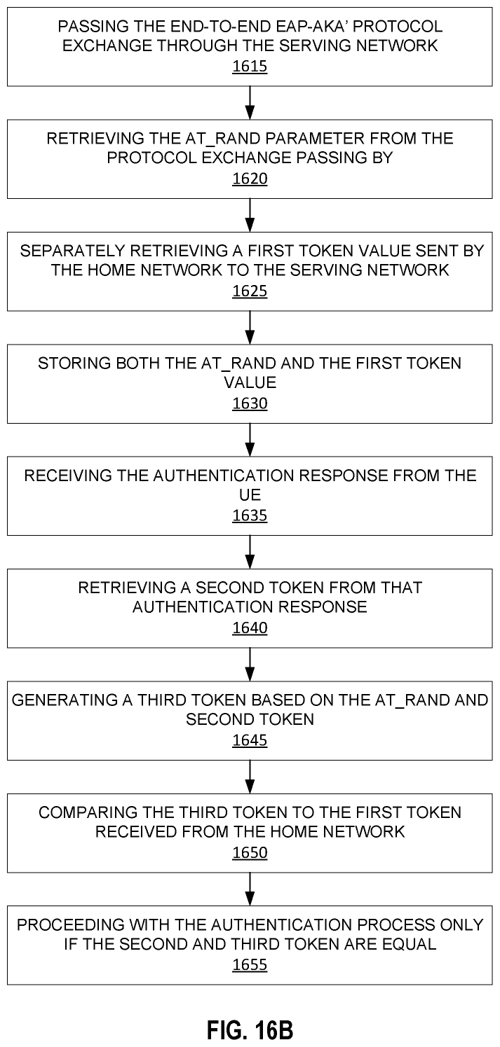

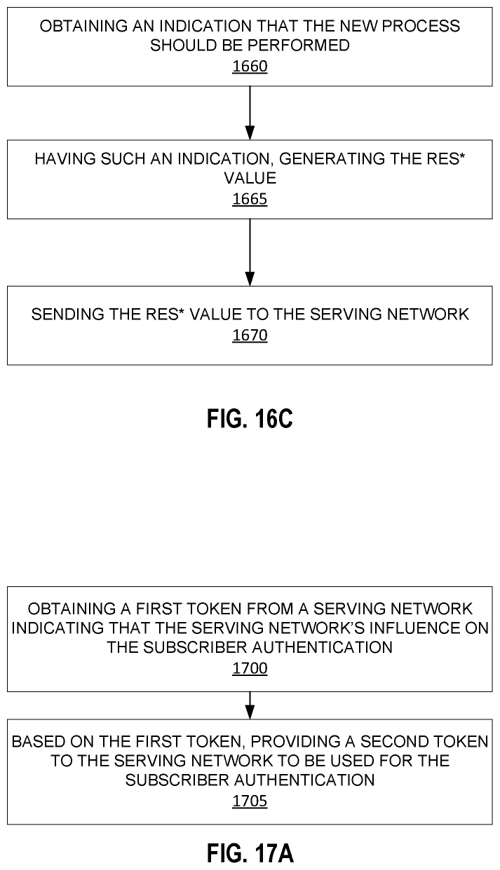

FIGS. 16A-16C illustrate methods according to Embodiment 1. FIG. 16A in this regard shows a method performed by a home network during a subscriber authentication. The method as shown comprises acting as the endpoint for the end-to-end EAP-AKA′ protocol exchange with the UE (Block 1600). The method also comprises providing an indication to the UE that a new, modified process needs to be run (Block 1605). The method further comprises, outside the EAP-AKA′ exchange, providing a first token to the serving network to be used for the subscriber authentication (not to be sent to the UE) (Block 1610).

In some embodiments, the first token comprising of HXRES*.

In some embodiments, the indication comprising of the use of a new EAP method type for EAP-AKA′.

In some embodiments, the indication comprising of the use of a new attribute value inside EAP-AKA′.

In some embodiments, the indication comprising of the use of a message or attribute sent to the serving network that uses underlying communication means to signal to the UE about the indication. In one embodiment, the NAS protocol is those underlying communication means.

FIG. 16B in this regard shows a method performed by a serving network during a subscriber authentication. The method comprises passing the end-to-end EAP-AKA′ protocol exchange through the serving network (Block 1615). The method further comprises retrieving the AT_RAND parameter from the protocol exchange passing by (Block 1620). The method also comprises separately retrieving a first token value sent by the home network to the serving network (Block 1625). The method moreover comprises storing both the AT_RAND and the first token value (Block 1630). The method also comprises receiving the authentication response from the UE (Block 1635). The method further comprises retrieving a second token from that authentication response (Block 1640). The method also comprises generating a third token based on the AT_RAND and second token (Block 1645). The method further comprises comparing the third token to the first token received from the home network (Block 1650). And the method comprises proceeding with the authentication process only if the second and third token are equal (Block 1655).

In some embodiments, the first token comprising of HXRES*. In some embodiments, the second token comprising of RES*. In some embodiments, the third token comprising of HRES*.

In some embodiments, changing the EAP-AKA′ process so that AT_RES is not communicated, as discussed for embodiment 1b-eap.

FIG. 16C shows a method performed by the UE. The method comprises obtaining an indication that the new process should be performed (Block 1660). The method also comprises, having such an indication, generating the RES* value (Block 1665). The method further comprises sending the RES* value to the serving network (Block 1670).

In some embodiments, the indication received via the use of a different EAP method type code.

In some embodiments, the indication received via the use of an extra attribute in the EAP-AKA′ protocol.

In some embodiments, the indication through underlying communication means. In one embodiment, the underlying communication means is the NAS protocol.

In some embodiments, the EAP-AKA′ process is changed so that AT_RES is not communicated by the UE, as discussed for embodiment 1b-eap.

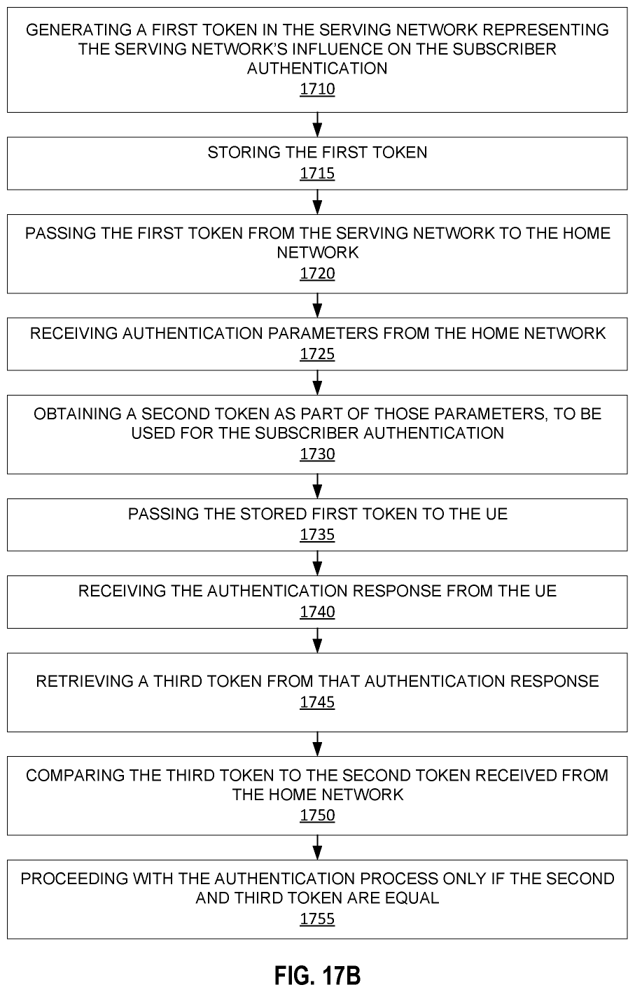

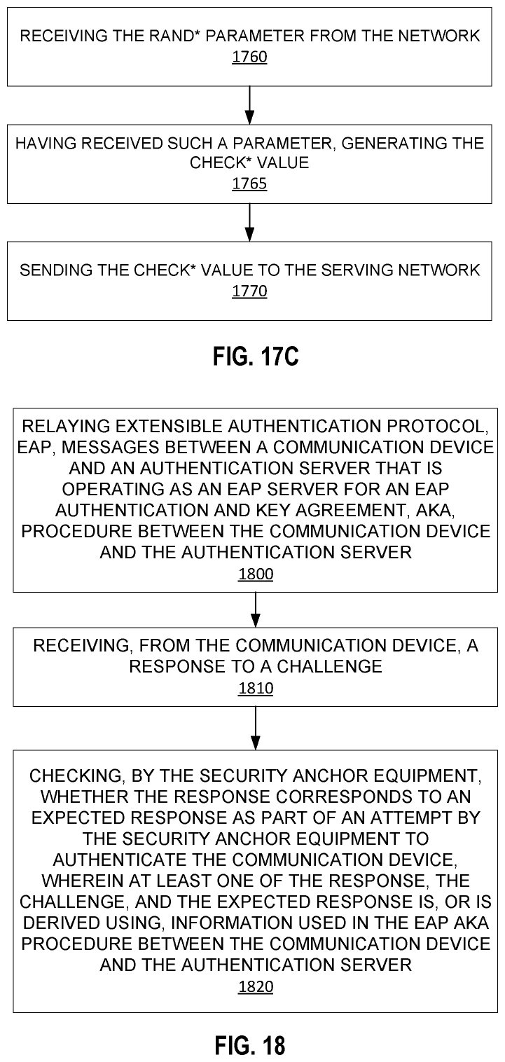

FIGS. 17A-17C show methods according to Embodiment 2. FIG. 17A in this regard shows a method performed by a home network during a subscriber authentication. The method comprises obtaining a first token from a serving network indicating that the serving network's influence on the subscriber authentication (Block 1700). The method also comprises, based on the first token, providing a second token to the serving network to be used for the subscriber authentication (Block 1705).

In some embodiments, the subscriber authentication comprises EAP or AKA.

In some embodiments, the first token comprises RAND*. In other embodiments, the first token comprises IND.

In some embodiments, the second token comprises XCHECK*. In other embodiments, the second token comprises Kxcheck.

FIG. 17B shows a method performed by a serving network during a subscriber authentication. The method comprising generating a first token in the serving network representing the serving network's influence on the subscriber authentication (Block 1710). The method also comprises storing the first token (Block 1715) and passing the first token from the serving network to the home network (Block 1720). The method further comprises receiving authentication parameters from the home network (Block 1725).

The method also comprises obtaining a second token as part of those parameters, to be used for the subscriber authentication (Block 1730).

The method further comprises passing the stored first token to the UE (Block 1735).

The method moreover comprises receiving the authentication response from the UE (Block 1740) and retrieving a third token from that authentication response (Block 1745). The method comprises comparing the third token to the second token received from the home network (Block 1750) and proceeding with the authentication process only if the second and third token are equal (Block 1755).

In some embodiments, the subscriber authentication comprising of EAP or AKA.

In some embodiments, the first token comprising of RAND*. In other embodiments, the first token comprising of IND.

In some embodiments, the second token comprising of XCHECK*. In other embodiments, the second token comprising of Kxcheck.

FIG. 17C shows a method performed by the UE. The method comprises receiving the RAND* parameter from the network (Block 1760). The method further comprises, having received such a parameter, generating the CHECK value (Block 1765) and sending the CHECK* value to the serving network (Block 1770).

In view of the above modifications and variations, FIG. 18 depicts a method performed by security anchor equipment 20 in accordance with particular embodiments. The method includes relaying Extensible Authentication Protocol, EAP, messages 12M between a communication device 10 and an authentication server 30 that is operating as an EAP server for an EAP Authentication and Key Agreement, AKA, procedure 12 between the communication device 10 and the authentication server 30 (Block 1800). The method further comprises receiving, from the communication device 10, a response 16 to a challenge 14 (Block 1810). The method also comprises checking, by the security anchor equipment 20, whether the response 16 corresponds to an expected response 18 as part of an attempt by the security anchor equipment 20 to authenticate the communication device 10, wherein at least one of the response 16, the challenge 14, and the expected response 18 is, or is derived using, information used in the EAP AKA procedure 12 between the communication device 10 and the authentication server 30 (Block 1820).

In some embodiments, information used in the EAP AKA procedure 12 between the communication device 10 and the authentication server 30 includes a random token RAND 12T. In some embodiments, at least one of the response 16, the challenge 14, and the expected response 18 is, or is derived using, the random token RAND 12T. In one or more of these embodiments, the challenge 14 is the random token RAND 12T. In one or more of these embodiments, the response 16 and/or the expected response 18 is derived using the random token RAND 12T. In one or more of these embodiments, the method further comprises receiving the random token RAND 12T from the authentication server 30. In one or more of these embodiments, checking whether the response 16 corresponds to the expected response 18 comprises generating a response token 15 from the response 16 and the random token RAND 12T. Checking whether the response 16 corresponds to the expected response 18 also comprises checking whether the response token 15 is equal to the expected response 18. In one or more of these embodiments, the method further comprises receiving an EAP AKA message from the authentication server 30 and retrieving the random token RAND 12T from the EAP AKA message. In one or more of these embodiments, the random token RAND 12T is received in a message that is not an EAP AKA message. In one or more of these embodiments, the random token RAND 12T is received in an Authentication, Authorization, and Accounting, AAA, message. Alternatively, the random token RAND 12T is received in Serviced-Based Architecture, SBA, data carried in an application layer message.

In some embodiments, information used in the EAP AKA procedure 12 between the communication device 10 and the authentication server 30 includes a cryptographic key 17. In some embodiments, the response 16 and/or the expected response 18 is derived using the cryptographic key 17. In one or more of these embodiments, the cryptographic key 17 is shared between, or is generatable by each of, the communication device 10 and the authentication server 30.

In some embodiments, the expected response 18 is derived using information used in the EAP AKA procedure 12 between the communication device 10 and the authentication server 30. In one or more of these embodiments, the response 16 is a response RES* and wherein the expected response 18 is an expected response HXRES*. In one or more of these embodiments, the response 16 is a response CHECK* and wherein the expected response 18 is an expected check value XCHECK*.

In some embodiments, the method further comprises receiving the expected response 18 from the authentication server 30. In one or more of these embodiments, the expected response 18 is received within an Authentication, Authorization, and Accounting, AAA, message. In one or more of these embodiments, the expected response 18 is received within Serviced-Based Architecture, SBA, data carried in an application layer message.

In some embodiments, the method further comprises deriving the expected response 18 from information used in the EAP AKA procedure 12 between the communication device 10 and the authentication server 30. In one or more of these embodiments, information used in the EAP AKA procedure 12 between the communication device 10 and the authentication server 30 includes a random token RAND 12T. In some embodiments, deriving the expected response 18 comprises deriving the expected response 18 from the random token RAND 12T. In one or more of these embodiments, said deriving comprises deriving the expected response 18 also using a random token 12T generated by the security anchor equipment 20. In one or more of these embodiments, said deriving comprises deriving the expected response 18 also using a cryptographic key 17 received from the authentication server 30. In one or more of these embodiments, the method further comprises transmitting a request for the cryptographic key 17 to the authentication server 30, and receiving the cryptographic key 17 from the authentication server 30 in response to the request.

In some embodiments, the response 16 is received from the communication device 10 in a Non-Access Stratum, NAS, message.

In some embodiments, the method further comprises receiving an EAP AKA message from the communication device 10 and extracting the response 16 from the EAP AKA message.

In some embodiments, the method further comprises transmitting, to the authentication server 30 and/or to the communication device 10, signaling indicating a result of said checking by the security anchor equipment 20.

In some embodiments, the method further comprises authenticating or rejecting the communication device 10 depending on a result of said checking.

In some embodiments, the challenge 14 is a random token RAND* 12T generated by the security anchor equipment 20.

In some embodiments, the expected response 18 is derived using a random token RAND* 12T generated by the security anchor equipment 20. In one or more of these embodiments, the method further comprises transmitting the random token RAND* 12T to the authentication server 30.

In some embodiments, the security anchor equipment 20 implements a Security Anchor Function, SEAF.

In some embodiments, the security anchor equipment 20 is configured for use in a serving network 50S of the communication device 10.

In some embodiments, the authentication server 30 is configured for use in a home network 50H of the communication device 10.

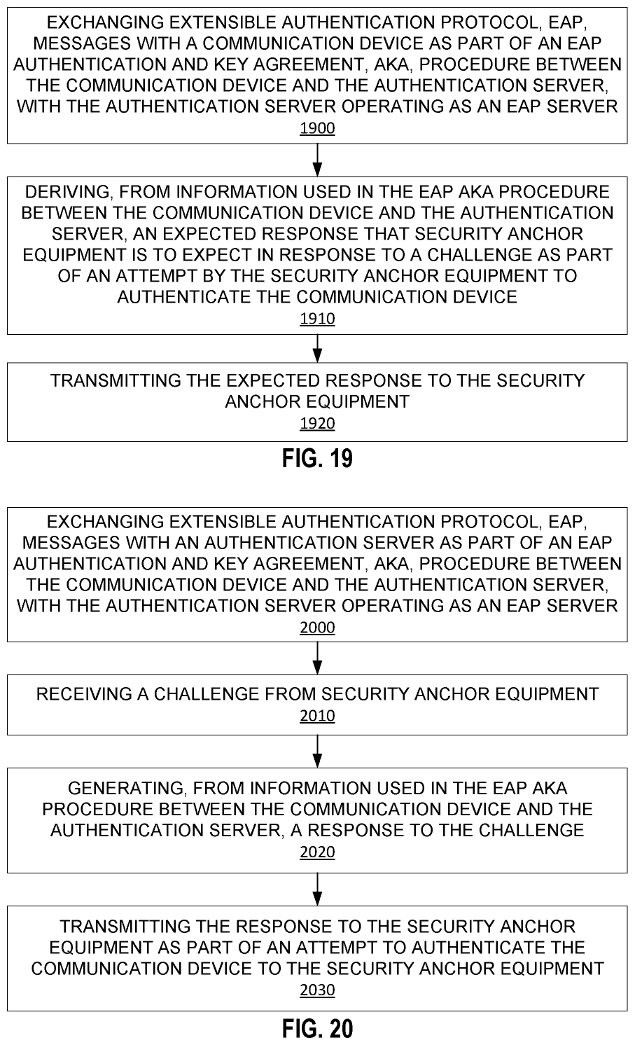

FIG. 19 depicts a method performed by an authentication server 30 in accordance with other particular embodiments. The method includes exchanging Extensible Authentication Protocol, EAP, messages 12M with a communication device 10 as part of an EAP Authentication and Key Agreement, AKA, procedure 12 between the communication device 10 and the authentication server 30, with the authentication server 30 operating as an EAP server (Block 1900). The method also comprises deriving, from information used in the EAP AKA procedure 12 between the communication device 10 and the authentication server 30, an expected response 18 that security anchor equipment 20 is to expect in response to a challenge 14 as part of an attempt by the security anchor equipment 20 to authenticate the communication device 19 (Block 1910). The method further comprises transmitting the expected response 18 to the security anchor equipment 20 (Block 1920).

In some embodiments, information used in the EAP AKA procedure 12 between the communication device 10 and the authentication server 30 includes a random token RAND 12T. In some embodiments, the expected response 18 is derived using the random token RAND 12T. In one or more of these embodiments, the challenge 14 is the random token RAND 12T. In one or more of these embodiments, the method further comprises transmitting the random token RAND 12T to the security anchor equipment 20 in a message that is not an EAP AKA message. In one or more of these embodiments, the method further comprises transmitting the random token RAND 12T to the security anchor equipment 20 in an Authentication, Authorization, and Accounting, AAA, message. Alternatively, the method further comprises transmitting the random token RAND 12T to the security anchor equipment 20 in Serviced-Based Architecture, SBA, data carried in an application layer message.

In some embodiments, information used in the EAP AKA procedure 12 between the communication device 10 and the authentication server 30 includes a cryptographic key 17. In some embodiments, the expected response 18 is derived using the cryptographic key 17. In one or more of these embodiments, the cryptographic key 17 is shared between, or is generatable by each of, the communication device 10 and the authentication server 30.

In some embodiments, the expected response 18 is an expected response HXRES*.

In some embodiments, the expected response 18 is an expected check value XCHECK*.

In some embodiments, transmitting the expected response 18 comprises transmitting the expected response 18 to the security anchor equipment 20 within a message that is not an EAP AKA message.

In some embodiments, transmitting the expected response 18 comprises transmitting the expected response 18 to the security anchor equipment 20 within an Authentication, Authorization, and Accounting, AAA, message

In some embodiments, transmitting the expected response 18 comprises transmitting the expected response 18 to the security anchor equipment 20 within Serviced-Based Architecture, SBA, data carried in an application layer message.

In some embodiments, said deriving comprises deriving the expected response 18 also from a random token 12T generated by the security anchor equipment 20. In one or more of these embodiments, the method further comprises receiving the random token 12T from the security anchor equipment 20. In one or more of these embodiments, the random token 12T is received in a message that is not an EAP AKA message. In one or more of these embodiments, the random token 12T is received in an Authentication, Authorization, and Accounting, AAA, message. Alternatively, the random token 12T is received in Serviced-Based Architecture, SBA, data carried in an application layer message.

In some embodiments, the method further comprises receiving, from the security anchor equipment 20, signaling indicating a result of the attempt by the security anchor equipment 20 to authenticate the communication device 10. In one or more of these embodiments, the method further comprises authenticating or rejecting the communication device 10 depending at least in part on the indicated result.

In some embodiments, the challenge 14 is a random token RAND* 12T generated by the security anchor equipment 20.

In some embodiments, the expected response 18 is derived using a random token RAND* 12T generated by the security anchor equipment 20. In one or more of these embodiments, the method further comprises receiving the random token RAND* 12T from the security anchor equipment 20.

In some embodiments, the authentication server 30 implements an Authentication Server Function, AUSF.

In some embodiments, the authentication server 30 is configured for use in a home network 50H of the communication equipment.

In some embodiments, the security anchor equipment 20 is configured for use in a serving network 50S of the communication equipment.

FIG. 20 depicts a method performed by a communication device 10 in accordance with other particular embodiments. The method includes exchanging Extensible Authentication Protocol, EAP, messages 12M with an authentication server 30 as part of an EAP Authentication and Key Agreement, AKA, procedure 12 between the communication device 10 and the authentication server 30, with the authentication server 30 operating as an EAP server (Block 2000). The method also comprises receiving a challenge 14 from security anchor equipment 20 (Block 2010). The method further comprises generating, from information used in the EAP AKA procedure 12 between the communication device 10 and the authentication server 30, a response 16 to the challenge 14 (Block 2020). The method further comprises transmitting the response 16 to the security anchor equipment 20 as part of an attempt to authenticate the communication device 10 to the security anchor equipment 20 (Block 2030).

In some embodiments, information used in the EAP AKA procedure 12 between the communication device 10 and the authentication server 30 includes a random token RAND 12T. In some embodiments, the response 16 is derived using the random token RAND 12T. In one or more of these embodiments, the challenge 14 is the random token RAND 12T.

In some embodiments, information used in the EAP AKA procedure 12 between the communication device 10 and the authentication server 30 includes a cryptographic key 17. In some embodiments, the response 16 is derived using the cryptographic key 17. In one or more of these embodiments, the cryptographic key 17 is shared between, or is generatable by each of, the communication device 10 and the authentication server 30.

In some embodiments, the response 16 is a response RES*.

In some embodiments, the response 16 is a response CHECK**.

In some embodiments, transmitting the response 16 comprises transmitting the response 16 to the security anchor equipment 20 within an EAP AKA message.

In some embodiments, transmitting the response 16 comprises transmitting the response 16 to the security anchor equipment 20 within a Non-Access Stratum, NAS, message.

In some embodiments, said deriving comprises deriving the response 16 from a random token 12T generated by the security anchor equipment 20. In one or more of these embodiments, the method further comprises receiving the random token 12T from the security anchor equipment 20. In one or more of these embodiments, the random token 12T is received within a Non-Access Stratum, NAS, message.

In some embodiments, the method further comprises receiving, from the security anchor equipment 20, signaling indicating a result of the attempt to authenticate the communication device 10 to the security anchor equipment 20.

In some embodiments, the challenge 14 is a random token RAND* 12T generated by the security anchor equipment 20.

In some embodiments, the response 16 is derived using a random token RAND* 12T generated by the security anchor equipment 20. In one or more of these embodiments, the method further comprises receiving the random token RAND* 12T from the security anchor equipment 20.

In some embodiments, the authentication server 30 is configured for use in a home network 50H of the communication equipment.

In some embodiments, the security anchor equipment 20 is configured for use in a serving network 50S of the communication equipment.

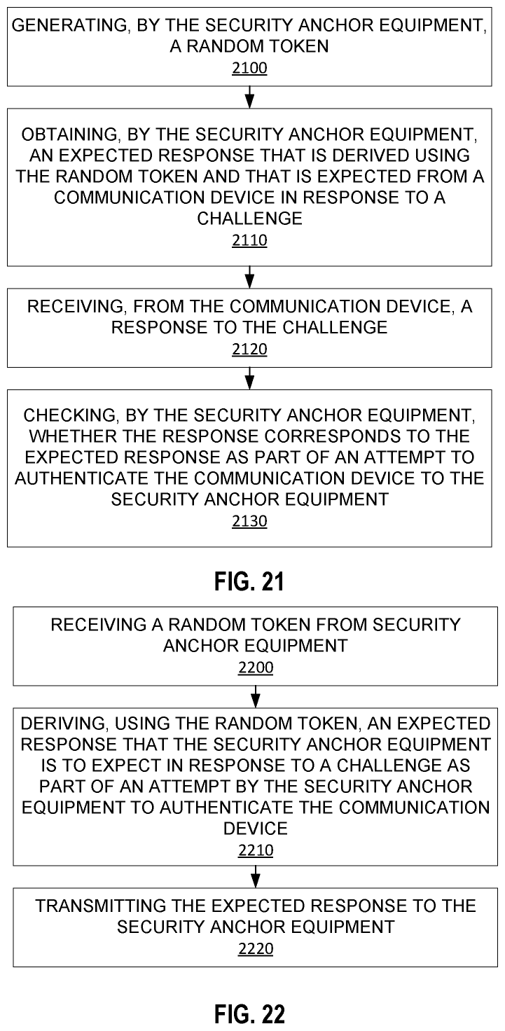

FIG. 21 depicts a method performed by security anchor equipment 20 in accordance with yet other particular embodiments. The method includes generating, by the security anchor equipment 20, a random token 20T (Block 2100). The method also comprises obtaining, by the security anchor equipment 20, an expected response 28 that is derived using the random token 20T and that is expected from a communication device 10 in response to a challenge 24 (Block 2110). The method further comprises receiving, from the communication device 10, a response 26 to the challenge 24 (Block 2120). The method also comprises checking, by the security anchor equipment 20, whether the response 26 corresponds to the expected response 28 as part of an attempt to authenticate the communication device 10 to the security anchor equipment 20 (Block 2130).

In some embodiments, the challenge 24 is the random token 20T.

In some embodiments, the method further comprises transmitting the random token 20T to an authentication server 30. The method further comprises, after transmitting the random token 20T, receiving the expected response 28 from the authentication server 30. In one or more of these embodiments, the expected response 28 is received within a message that is not an EAP AKA message. In one or more of these embodiments, the expected response 28 is received within an Authentication, Authorization, and Accounting, AAA, message. In one or more of these embodiments, the expected response 28 is received within Serviced-Based Architecture, SBA, data carried in an application layer message.

In some embodiments, the method further comprises receiving a cryptographic key 32 from the home network 50H. The method further comprises generating the expected response 28 from the cryptographic key 32 and the random token 20T. In one or more of these embodiments, the method further comprises transmitting a request for the cryptographic key 32 to the authentication server 30. In some embodiments, the cryptographic key 32 is received in response to the request. In one or more of these embodiments, the cryptographic key 32 is received within a message that is not an EAP AKA message. In one or more of these embodiments, the cryptographic key 32 is received within an Authentication, Authorization, and Accounting, AAA, message. In one or more of these embodiments, the cryptographic key 32 is received within Serviced-Based Architecture, SBA, data carried in an application layer message.

In some embodiments, checking whether the response 26 corresponds to the expected response 28 comprises generating a response token 15 from the response 26 and the random token 20T. Checking whether the response 26 corresponds to the expected response 28 also comprises checking whether the response token 15 is equal to the expected response 28.

In some embodiments, the method further comprises transmitting the random token 20T to the communication device 10. In one or more of these embodiments, the random token 20T is transmitted to the communication device 10 within a Non-Access Stratum, NAS, message.

In some embodiments, the method further comprises relaying Extensible Authentication Protocol, EAP, messages between the communication device 10 and the authentication server 30 as part of an EAP Authentication and Key Agreement, AKA, procedure 12 between the communication device 10 and the authentication server 30. In some embodiments, at least one of the response 26, the challenge 24, and the expected response 28 is, or is derived using, information used in the EAP AKA procedure 12 between the communication device 10 and the authentication server 30. In one or more of these embodiments, information used in the EAP AKA procedure 12 between the communication device 10 and the authentication server 30 includes a random token RAND 20T generated by the authentication server 30. In some embodiments, at least one of the response 26, the challenge 24, and the expected response 28 is, or is derived using, the random token RAND 20T generated by the authentication server 30. In one or more of these embodiments, the challenge 24 is the random token RAND 20T generated by the authentication server 30. In one or more of these embodiments, the expected response 28 is also derived using the random token RAND 20T generated by the authentication server 30. In one or more of these embodiments, the method further comprises receiving the random token RAND 20T from the authentication server 30. In one or more of these embodiments, the method further comprises receiving an EAP AKA message from the authentication server 30 and retrieving the random token RAND 20T from the EAP AKA message. In one or more of these embodiments, the random token RAND 20T is received in a message that is not an EAP AKA message. In one or more of these embodiments, the random token RAND 20T is received in an Authentication, Authorization, and Accounting, AAA, message. Alternatively, the random token RAND 20T is received in Serviced-Based Architecture, SBA, data carried in an application layer message. In one or more of these embodiments, information used in the EAP AKA procedure 12 between the communication device 10 and the authentication server 30 includes a cryptographic key 32. In some embodiments, the response 26 and/or the expected response 28 is derived using the cryptographic key 32. In one or more of these embodiments, the cryptographic key 32 is shared between, or is generatable by each of, the communication device 10 and the authentication server 30.

In some embodiments, the response 26 is a response CHECK* and wherein the expected response 28 is an expected check value XCHECK*.

In some embodiments, the response 26 is received from the communication device 10 in a Non-Access Stratum, NAS, message.

In some embodiments, the method further comprises transmitting, to the authentication server 30 and/or to the communication device 10, signaling indicating a result of said checking by the security anchor equipment 20.

In some embodiments, the method further comprises authenticating or rejecting the communication device 10 depending on a result of said checking.

In some embodiments, the security anchor equipment 20 implements a Security Anchor Function, SEAF.

In some embodiments, said checking is performed as part of, or during, a 5G AKA procedure between the communication device 10 and the h authentication server 30.

In some embodiments, said checking is performed as part of, or during, an EAP AKA procedure 12 between the communication device 10 and the authentication server 30.

In some embodiments, the authentication server 30 is configured for use in a home network 50H of the communication equipment.

In some embodiments, the security anchor equipment 20 is configured for use in a serving network 50S of the communication equipment.

FIG. 22 depicts a method performed by performed by an authentication server 30 in accordance with still other particular embodiments. The method includes receiving a random token 20T from security anchor equipment 20 (Block 2200). The method further comprises deriving, using the random token 20T, an expected response 28 that the security anchor equipment 20 is to expect in response to a challenge 24 as part of an attempt by the security anchor equipment 20 to authenticate the communication device 10 (Block 2210). The method also comprises transmitting the expected response 28 to the security anchor equipment 20 (Block 2220).

In some embodiments, the expected response 28 is transmitted within a message that is not an EAP AKA message.

In some embodiments, the expected response 28 is transmitted within an Authentication, Authorization, and Accounting, AAA, message.

In some embodiments, the expected response 28 is transmitted within Serviced-Based Architecture, SBA, data carried in an application layer message.

In some embodiments, the method further comprises exchanging Extensible Authentication Protocol, EAP, messages 12M between the communication device 10 and the authentication server 30 as part of an EAP Authentication and Key Agreement, AKA, procedure 12 between the communication device 10 and the authentication server 30. In some embodiments, at least one of the challenge 24 and the expected response 28 is, or is derived using, information used in the EAP AKA procedure 12 between the communication device 10 and the authentication server 30. In one or more of these embodiments, information used in the EAP AKA procedure 12 between the communication device 10 and the authentication server 30 includes a random token RAND 20T generated by the authentication server 30. In some embodiments, deriving the expected response 28 comprises deriving the expected response 28 also using the random token RAND 20T generated by the authentication server 30. In one or more of these embodiments, information used in the EAP AKA procedure 12 between the communication device 10 and the authentication server 30 includes a random token RAND 20T generated by the authentication server 30. In some embodiments, the challenge 24 is the random token RAND 20T generated by the authentication server 30. In one or more of these embodiments, the method further comprises transmitting, from the authentication server 30 to the security anchor equipment 20, the random token RAND 20T generated by the authentication server 30. In one or more of these embodiments, the method further comprises transmitting an EAP AKA message from the authentication server 30 to the security anchor equipment 20. In some embodiments, the random token 20T generated by the authentication server 30 is included in the EAP AKA message. In one or more of these embodiments, transmitting, from the authentication server 30 to the security anchor equipment 20, the random token RAND 20T generated by the authentication server 30 comprises transmitting the random token RAND 20T generated by the authentication server 30 in a message that is not an EAP AKA message. In one or more of these embodiments, from the authentication server 30 to the security anchor equipment 20, the random token RAND 20T generated by the authentication server 30 comprises transmitting the random token RAND 20T generated by the authentication server 30 in an Authentication, Authorization, and Accounting, AAA, message. Alternatively, transmitting, from the authentication server 30 to the security anchor equipment 20, the random token RAND 20T generated by the authentication server 30 comprises transmitting the random token RAND 20T generated by the authentication server 30 in Serviced-Based Architecture, SBA, data carried in an application layer message. In one or more of these embodiments, information used in the EAP AKA procedure 12 between the communication device 10 and the authentication server 30 includes a cryptographic key 32, wherein the expected response 28 is derived also using the cryptographic key 32. In one or more of these embodiments, the cryptographic key 32 is shared between, or is generatable by each of, the communication device 10 and the authentication server 30.

In some embodiments, the expected response 28 is an expected check value XCHECK*.

In some embodiments, the security anchor equipment 20 implements a Security Anchor Function, SEAF.

In some embodiments, the attempt by the security anchor equipment 20 to authenticate the communication device 10 is performed as part of, or during, a 5G AKA procedure between the communication device 10 and the authentication server 30.

In some embodiments, the attempt by the security anchor equipment 20 to authenticate the communication device 10 is performed as part of, or during, an EAP AKA procedure 12 between the communication device 10 and the authentication server 30.

In some embodiments, the authentication server 30 is configured for use in a home network 50H of the communication equipment.

In some embodiments, the security anchor equipment 20 is configured for use in a serving network 50S of the communication equipment.

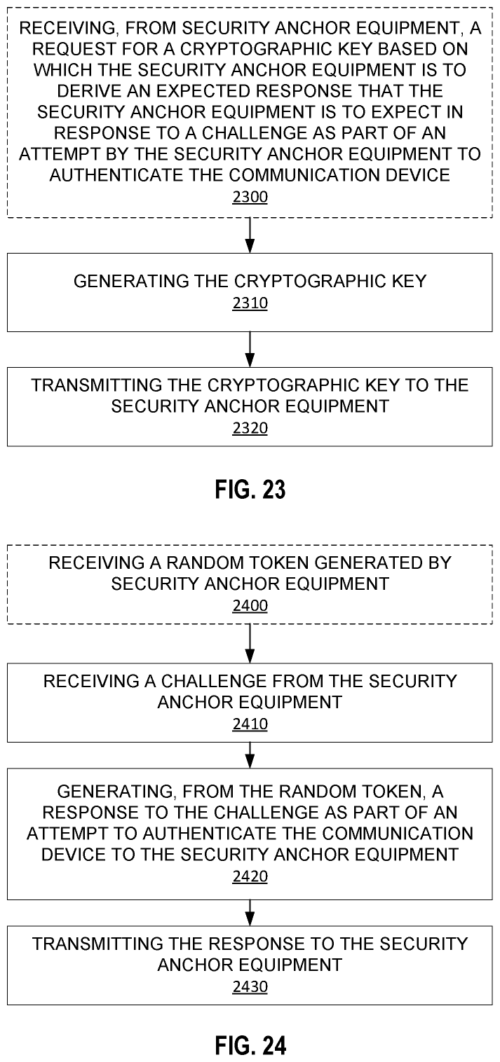

FIG. 23 depicts a method performed by performed by an authentication server 30 in accordance with still other particular embodiments. The method includes receiving, from security anchor equipment 20, a request for a cryptographic key 32 based on which the security anchor equipment 20 is to derive an expected response 28 that the security anchor equipment 20 is to expect in response to a challenge 24 as part of an attempt by the security anchor equipment 20 to authenticate the communication device 10 (Block 2300). The method also comprises generating the cryptographic key 32 (Block 2310). The method also comprises transmitting the cryptographic key 32 to the security anchor equipment 20 (Block 2320).

In other embodiments, though, the cryptographic key 32 may be transmitted to the security anchor equipment 20 proactively, without the request.

In some embodiments, the cryptographic key 32 is transmitted within a message that is not an EAP AKA message.

In some embodiments, the cryptographic key 32 is transmitted within an Authentication, Authorization, and Accounting, AAA, message.

In some embodiments, the cryptographic key 32 is transmitted within Serviced-Based Architecture, SBA, data carried in an application layer message.

In some embodiments, the method further comprises exchanging Extensible Authentication Protocol, EAP, messages 12M between the communication device 10 and the authentication server 30 as part of an EAP Authentication and Key Agreement, AKA, procedure 12 between the communication device 10 and the authentication server 30. In some embodiments, at least one of the challenge 24 and the expected response 28 is, or is derived using, information used in the EAP AKA procedure 12 between the communication device 10 and the authentication server 30. In one or more of these embodiments, information used in the EAP AKA procedure 12 between the communication device 10 and the authentication server 30 includes a random token RAND 20T generated by the authentication server 30. In some embodiments, the expected response 28 is to be derived also using the random token RAND 20T generated by the authentication server 30. In one or more of these embodiments, information used in the EAP AKA procedure 12 between the communication device 10 and the authentication server 30 includes a random token RAND 20T generated by the authentication server 30. In some embodiments, the challenge 24 is the random token RAND 20T generated by the authentication server 30. In one or more of these embodiments, the method further comprises transmitting, from the authentication server 30 to the security anchor equipment 20, the random token RAND 20T generated by the authentication server 30. In one or more of these embodiments, the method further comprises transmitting an EAP AKA message from the authentication server 30 to the security anchor equipment 20. In some embodiments, the random token generated by the authentication server 30 is included in the EAP AKA message. In one or more of these embodiments, transmitting, from the authentication server 30 to the security anchor equipment 20, the random token RAND 20T generated by the authentication server 30 comprises transmitting the random token RAND 20T generated by the authentication server 30 in a message that is not an EAP AKA message. In one or more of these embodiments, transmitting, from the authentication server 30 to the security anchor equipment 20, the random token RAND 20T generated by the authentication server 30 comprises transmitting the random token RAND 20T generated by the authentication server 30 in an Authentication, Authorization, and Accounting, AAA, message. Alternatively, transmitting, from the authentication server 30 to the security anchor equipment 20, the random token RAND 20T generated by the authentication server 30 comprises transmitting the random token RAND 20T generated by the authentication server 30 in Serviced-Based Architecture, SBA, data carried in an application layer message.

In some embodiments, the expected response 28 is an expected check value XCHECK*.

In some embodiments, the security anchor equipment 20 implements a Security Anchor Function, SEAF.

In some embodiments, the attempt by the security anchor equipment 20 to authenticate the communication device 10 is performed as part of, or during, a 5G AKA procedure between the communication device 10 and the authentication server 30.

In some embodiments, the attempt by the security anchor equipment 20 to authenticate the communication device 10 is performed as part of, or during, an EAP AKA procedure 12 between the communication device 10 and the authentication server 30.

In some embodiments, the authentication server 30 is configured for use in a home network 50H of the communication equipment.

In some embodiments, the security anchor equipment 20 is configured for use in a serving network 50S of the communication equipment.

FIG. 24 depicts a method performed by performed by a communication device 10 in accordance with still other particular embodiments. The method includes receiving a random token 20T generated by security anchor equipment 20 (Block 2400) and receiving a challenge 24 from the security anchor equipment 20 (Block 2410). The method also comprises generating, from the random token 20T, a response 26 to the challenge 24 as part of an attempt to authenticate the communication device 10 to the security anchor equipment 20 (Block 2420). The method further comprises transmitting the response 26 to the security anchor equipment 20 (Block 2430).

In some embodiments, the response 26 is transmitted within a message that is not an EAP AKA message.

In some embodiments, the response 26 is transmitted within an Authentication, Authorization, and Accounting, AAA, message.

In some embodiments, the response 26 is transmitted within Serviced-Based Architecture, SBA, data carried in an application layer message.

In some embodiments, the method further comprises exchanging Extensible Authentication Protocol, EAP, messages 12M between the communication device 10 and an authentication server 30 as part of an EAP Authentication and Key Agreement, AKA, procedure 12 between the communication device 10 and the authentication server 30. In some embodiments, at least one of the challenge 24 and the response 26 is, or is derived using, information used in the EAP AKA procedure 12 between the communication device 10 and the authentication server 30. In one or more of these embodiments, information used in the EAP AKA procedure 12 between the communication device 10 and the authentication server 30 includes a random token RAND 20T generated by the authentication server 30, wherein deriving the response 26 comprises deriving the response 26 also using the random token RAND 20T generated by the authentication server 30. In one or more of these embodiments, information used in the EAP AKA procedure 12 between the communication device 10 and the authentication server 30 includes a random token RAND 20T generated by the authentication server 30. In some embodiments, the challenge 24 is the random token RAND 20T generated by the authentication server 30.

In some embodiments, the random token 20T generated by security anchor equipment 20 is received in an EAP AKA message.

In some embodiments, the random token 20T generated by security anchor equipment 20 is received in a message that is not an EAP AKA message.

In some embodiments, the random token 20T generated by security anchor equipment 20 is received in an Authentication, Authorization, and Accounting, AAA, message.

Alternatively, the random token 20T generated by security anchor equipment 20 is received in Serviced-Based Architecture, SBA, data carried in an application layer message.

In some embodiments, the response 26 is a check value CHECK*.

In some embodiments, the security anchor equipment 20 implements a Security Anchor Function, SEAF.

In some embodiments, the attempt by the security anchor equipment 20 to authenticate the communication device 10 is performed as part of, or during, a 5G AKA procedure between the communication device 10 and the authentication server 30.

In some embodiments, the attempt by the security anchor equipment 20 to authenticate the communication device 10 is performed as part of, or during, an EAP AKA procedure 12 between the communication device 10 and the authentication server 30.

In some embodiments, the authentication server 30 is configured for use in a home network 50H of the communication equipment.

In some embodiments, the security anchor equipment 20 is configured for use in a serving network 50S of the communication equipment.

Embodiments herein also include corresponding apparatuses. Embodiments herein for instance include a communication device 10 configured to perform any of the steps of any of the embodiments described above for the communication device 10.

Embodiments also include a communication device 10 comprising processing circuitry and power supply circuitry. The processing circuitry is configured to perform any of the steps of any of the embodiments described above for the communication device 10. The power supply circuitry is configured to supply power to the communication device 10.

Embodiments further include a communication device 10 comprising processing circuitry. The processing circuitry is configured to perform any of the steps of any of the embodiments described above for the communication device 10. In some embodiments, the communication device 10 further comprises communication circuitry.

Embodiments further include a communication device 10 comprising processing circuitry and memory. The memory contains instructions executable by the processing circuitry whereby the communication device 10 is configured to perform any of the steps of any of the embodiments described above for the communication device 10.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 10. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include security anchor equipment 20 configured to perform any of the steps of any of the embodiments described above for the security anchor equipment 20.

Embodiments also include security anchor equipment 20 comprising processing circuitry and power supply circuitry. The processing circuitry is configured to perform any of the steps of any of the embodiments described above for the security anchor equipment 20. The power supply circuitry is configured to supply power to the security anchor equipment 20.

Embodiments further include security anchor equipment 20 comprising processing circuitry. The processing circuitry is configured to perform any of the steps of any of the embodiments described above for the security anchor equipment 20. In some embodiments, the security anchor equipment 20 further comprises communication circuitry.

Embodiments further include security anchor equipment 20 comprising processing circuitry and memory. The memory contains instructions executable by the processing circuitry whereby the security anchor equipment 20 is configured to perform any of the steps of any of the embodiments described above for the security anchor equipment 20.

Embodiments herein also include an authentication server 30 configured to perform any of the steps of any of the embodiments described above for the authentication server 30.

Embodiments also include an authentication server 30 comprising processing circuitry and power supply circuitry. The processing circuitry is configured to perform any of the steps of any of the embodiments described above for the authentication server 30. The power supply circuitry is configured to supply power to the authentication server 30.

Embodiments further include an authentication server 30 comprising processing circuitry. The processing circuitry is configured to perform any of the steps of any of the embodiments described above for the authentication server 30. In some embodiments, the authentication server 30 further comprises communication circuitry.

Embodiments further include an authentication server 30 comprising processing circuitry and memory. The memory contains instructions executable by the processing circuitry whereby the authentication server 30 is configured to perform any of the steps of any of the embodiments described above for the authentication server 30.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

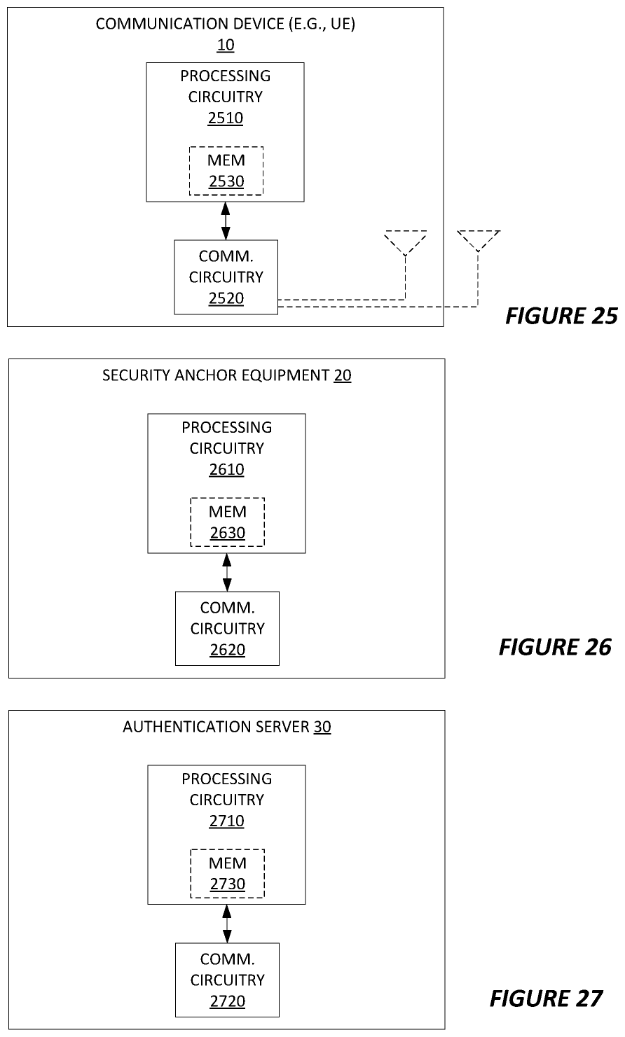

FIG. 25 for example illustrates a communication device 10 as implemented in accordance with one or more embodiments. As shown, the communication device 10 includes processing circuitry 2510 and communication circuitry 2520. The communication circuitry 2520 (e.g., radio circuitry) is configured to transmit and/or receive information to and/or from one or more other nodes, e.g., via any communication technology. Such communication may occur via one or more antennas that are either internal or external to the communication device 10. The processing circuitry 2510 is configured to perform processing described above, e.g., in FIGS. 20 and/or 24, such as by executing instructions stored in memory 2530. The processing circuitry 2510 in this regard may implement certain functional means, units, or modules.

FIG. 26 illustrates security anchor equipment 20 implemented in accordance with one or more embodiments. As shown, the security anchor equipment 20 includes processing circuitry 2610 and communication circuitry 2620. The communication circuitry 2620 is configured to transmit and/or receive information to and/or from one or more other nodes, e.g., via any communication technology. The processing circuitry 2610 is configured to perform processing described above, e.g., in FIGS. 18 and/or 21, such as by executing instructions stored in memory 2630. The processing circuitry 2610 in this regard may implement certain functional means, units, or modules.

FIG. 27 illustrates authentication server 30 implemented in accordance with one or more embodiments. As shown, the authentication server 30 includes processing circuitry 2610 and communication circuitry 2620. The communication circuitry 2620 is configured to transmit and/or receive information to and/or from one or more other nodes, e.g., via any communication technology. The processing circuitry 2610 is configured to perform processing described above, e.g., in FIGS. 19, 22, and/or 23, such as by executing instructions stored in memory 2630. The processing circuitry 2610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

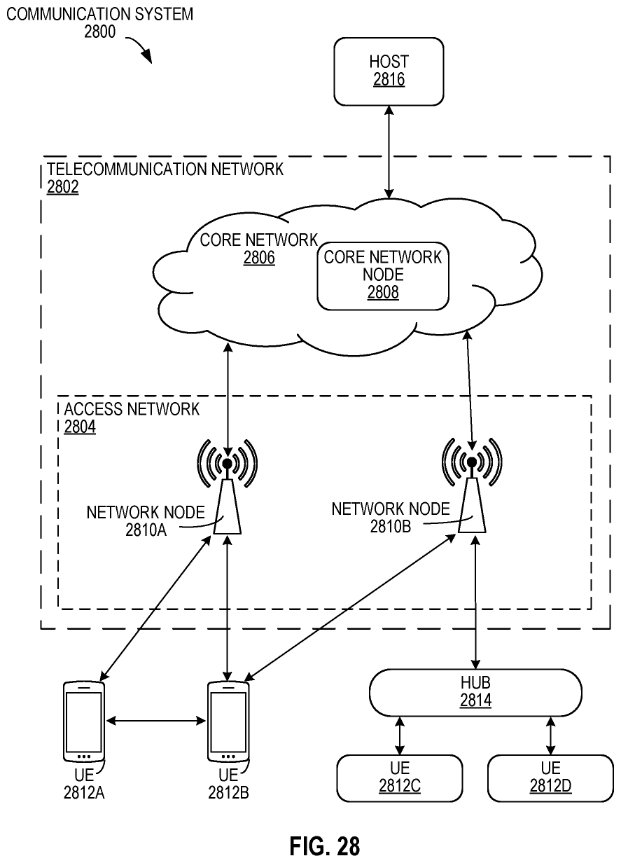

Certain embodiments may provide one or more of the following technical advantage(s). FIG. 28 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3^{rd} Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 28 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (Embb) services to other UEs, and/or Massive Machine Type Communication (Mmtc)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

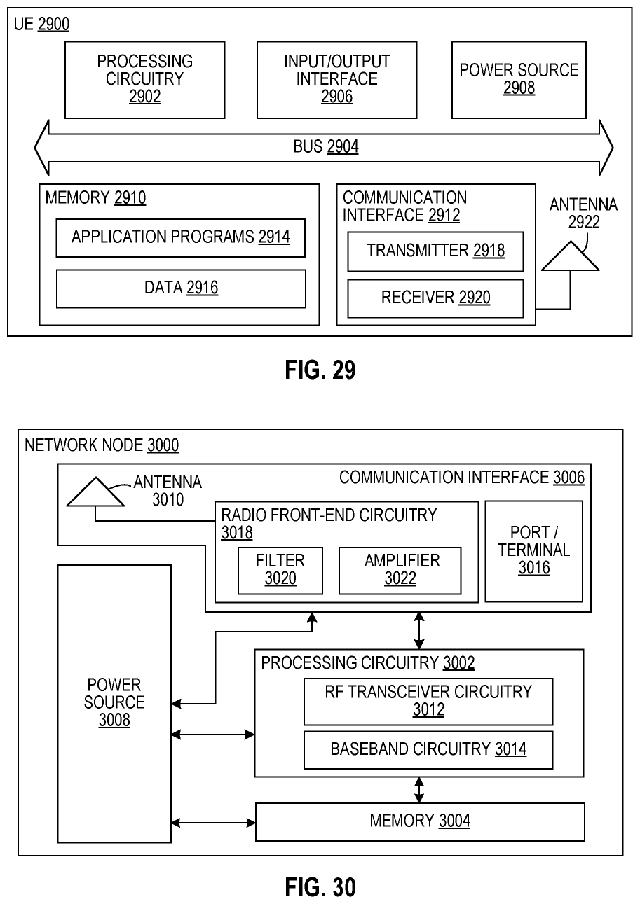

FIG. 29 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (Emtc) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 29. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (Euicc), integrated UICC (Iuicc) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 29.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 30 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 30 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

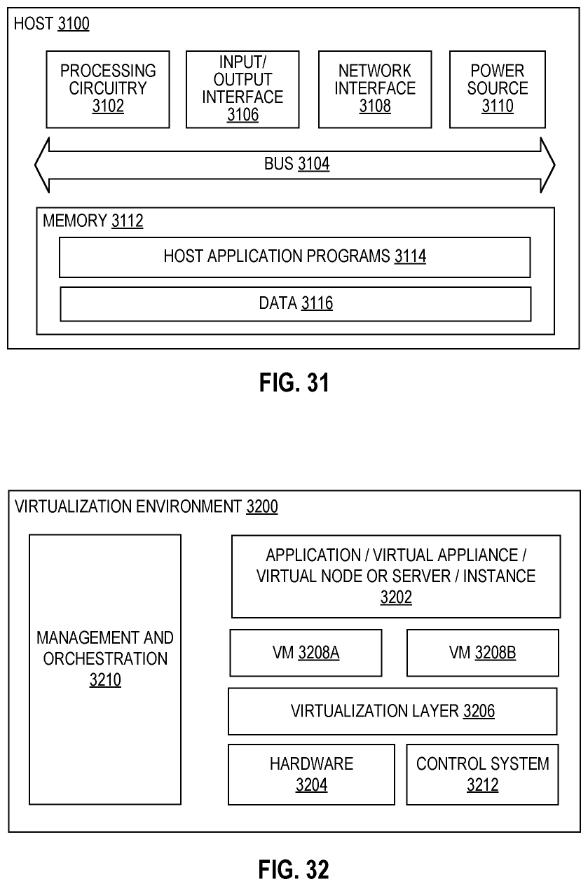

FIG. 31 is a block diagram of a host 3100, which may be an embodiment of the host 2816 of FIG. 28, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 29 and 30, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 32 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

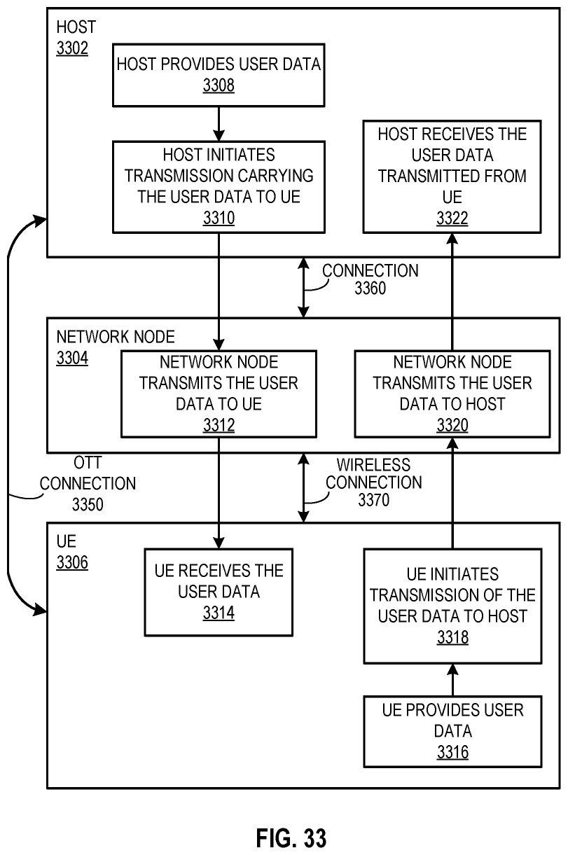

FIG. 33 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 28 and/or UE 2900 of FIG. 29), network node (such as network node 2810a of FIG. 28 and/or network node 3000 of FIG. 30), and host (such as host 2816 of FIG. 28 and/or host 3100 of FIG. 31) discussed in the preceding paragraphs will now be described with reference to FIG. 33.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 28) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term “A and/or B” as used herein covers embodiments having A alone, B alone, or both A and B together. The term “A and/or B” may therefore equivalently mean “at least one of any one or more of A and B”.

Example embodiments of the techniques and apparatus described herein include, but are not limited to, the following enumerated examples:

### Group A Embodiments

A1. A method performed by security anchor equipment, the method comprising:
relaying Extensible Authentication Protocol, EAP, messages between a communication device and an authentication server that is operating as an EAP server for an EAP Authentication and Key Agreement, AKA, procedure between the communication device and the authentication server;
receiving, from the communication device, a response to a challenge; and
checking, by the security anchor equipment, whether the response corresponds to an expected response as part of an attempt by the security anchor equipment to authenticate the communication device, wherein at least one of the response, the challenge, and the expected response is, or is derived using, information used in the EAP AKA procedure between the communication device and the authentication server.
   A2. The method of embodiment A1, wherein information used in the EAP AKA procedure between the communication device and the authentication server includes a random token RAND, wherein at least one of the response, the challenge, and the expected response is, or is derived using, the random token RAND.
   A3. The method of embodiment A2, wherein the challenge is the random token RAND.
   A4. The method of any of embodiments A2-A3, wherein the response and/or the expected response is derived using the random token RAND.
   A5. The method of embodiment A4, further comprising receiving the random token RAND from the authentication server.
   A6. The method of embodiment A5, wherein checking whether the response corresponds to the expected response comprises:
generating a response token from the response and the random token RAND; and
checking whether the response token is equal to the expected response.
   A7. The method of any of embodiments A5-A6, further comprising receiving an EAP AKA message from the authentication server and retrieving the random token RAND from the EAP AKA message.
   A7.5. The method of any of embodiments A5-A6, wherein the random token RAND is received in a message that is not an EAP AKA message.
   A8. The method of any of embodiments A5-A6, wherein the random token RAND is received in either:
an Authentication, Authorization, and Accounting, AAA, message; or
Serviced-Based Architecture, SBA, data carried in an application layer message.
   A9. The method of any of embodiments A1-A5, wherein information used in the EAP AKA procedure between the communication device and the authentication server includes a cryptographic key, wherein the response and/or the expected response is derived using the cryptographic key.
   A11. The method of embodiment A10, wherein the cryptographic key is shared between, or is generatable by each of, the communication device and the authentication server.
   A12. The method of any of embodiments A1-A11, wherein the expected response is derived using information used in the EAP AKA procedure between the communication device and the authentication server.
   A13. The method of embodiment A12, wherein the response is a response RES* and wherein the expected response is an expected response HXRES*.
   A14. The method of embodiment A12, wherein the response is a response CHECK* and wherein the expected response is an expected check value XCHECK*.
   A15. The method of any of embodiments A1-A14, further comprising receiving the expected response from the authentication server.
   A16. The method of embodiment A15, wherein the expected response is received within an Authentication, Authorization, and Accounting, AAA, message.
   A17. The method of embodiment A15, wherein the expected response is received within Serviced-Based Architecture, SBA, data carried in an application layer message.
   A18. The method of any of embodiments A1-A14, further comprising deriving the expected response from information used in the EAP AKA procedure between the communication device and the authentication server.
   A19. The method of embodiment A18, wherein information used in the EAP AKA procedure between the communication device and the authentication server includes a random token RAND, wherein deriving the expected response comprises deriving the expected response from the random token RAND.
   A20. The method of embodiment A19, wherein said deriving comprises deriving the expected response also using a random token generated by the security anchor equipment.
   A21. The method of any of embodiments A19-A20, wherein said deriving comprises deriving the expected response also using a cryptographic key received from the authentication server.
   A22. The method of embodiment A21, further comprising transmitting a request for the cryptographic key to the authentication server, and receiving the cryptographic key from the authentication server in response to the request.
   A23. The method of any of embodiments A1-A22, wherein the response is received from the communication device in a Non-Access Stratum, NAS, message.
   A23.5. The method of any of embodiments A1-A22, further comprising receiving an EAP AKA message from the communication device and extracting the response from the EAP AKA message.
   A24. The method of any of embodiments A1-A23, further comprising transmitting, to the authentication server and/or to the communication device, signaling indicating a result of said checking by the security anchor equipment.
   A25. The method of any of embodiments A1-A24, further comprising authenticating or rejecting the communication device depending on a result of said checking.
   A26. The method of any of embodiments A1 and A3-A25, wherein the challenge is a random token RAND* generated by the security anchor equipment.
   A27. The method of any of embodiments A1-A26, wherein the expected response is derived using a random token RAND* generated by the security anchor equipment.
   A28. The method of any of embodiments A26-A27, further comprising transmitting the random token RAND* to the authentication server.
   A29. The method of any of embodiments A1-A28, wherein the security anchor equipment implements a Security Anchor Function, SEAF.
   A30. The method of any of embodiments A1-A29, wherein the security anchor equipment is configured for use in a serving network of the communication device.
   A31. The method of any of embodiments A1-A30, wherein the authentication server is configured for use in a home network of the communication device.

### Group B Embodiments

B1. A method performed by an authentication server, the method comprising:
exchanging Extensible Authentication Protocol, EAP, messages with a communication device as part of an EAP Authentication and Key Agreement, AKA, procedure between the communication device and the authentication server, with the authentication server operating as an EAP server;
deriving, from information used in the EAP AKA procedure between the communication device and the authentication server, an expected response that security anchor equipment is to expect in response to a challenge as part of an attempt by the security anchor equipment to authenticate the communication device; and
transmitting the expected response to the security anchor equipment.
   B2. The method of embodiment B1, wherein information used in the EAP AKA procedure between the communication device and the authentication server includes a random token RAND, wherein the expected response is derived using the random token RAND.
   B3. The method of embodiment B2, wherein the challenge is the random token RAND.
   B3.5. The method of any of embodiments B2-B3, further comprising transmitting the random token RAND to the security anchor equipment in a message that is not an EAP AKA message.
   B4. The method of any of embodiments B2-B3, further comprising transmitting the random token RAND to the security anchor equipment in either:
an Authentication, Authorization, and Accounting, AAA, message; or
Serviced-Based Architecture, SBA, data carried in an application layer message.
   B5. The method of any of embodiments B1-B4, wherein information used in the EAP AKA procedure between the communication device and the authentication server includes a cryptographic key, wherein the expected response is derived using the cryptographic key.
   B6. The method of embodiment B5, wherein the cryptographic key is shared between, or is generatable by each of, the communication device and the authentication server.
   B7. The method of any of embodiments B1-B6, wherein the expected response is an expected response HXRES*.
   B8. The method of any of embodiments B1-B6, wherein the expected response is an expected check value XCHECK*.
   B8.5. The method of any of embodiments B1-B8, wherein transmitting the expected response comprises transmitting the expected response to the security anchor equipment within a message that is not an EAP AKA message.
   B9. The method of any of embodiments B1-B8, wherein transmitting the expected response comprises transmitting the expected response to the security anchor equipment within an Authentication, Authorization, and Accounting, AAA, message.
   B10. The method of any of embodiments B1-B8, wherein transmitting the expected response comprises transmitting the expected response to the security anchor equipment within Serviced-Based Architecture, SBA, data carried in an application layer message.
   B11. The method of any of embodiments B1-B10, wherein said deriving comprises deriving the expected response also from a random token generated by the security anchor equipment.
   B12. The method of embodiment B11, further comprising receiving the random token from the security anchor equipment.
   B12.5. The method of embodiment B12, wherein the random token is received in a message that is not an EAP AKA message.
   B13. The method of embodiment B12, wherein the random token is received in either:
an Authentication, Authorization, and Accounting, AAA, message; or
Serviced-Based Architecture, SBA, data carried in an application layer message.
   B14. The method of any of embodiments B1-B13, further comprising receiving, from the security anchor equipment, signaling indicating a result of the attempt by the security anchor equipment to authenticate the communication device.
   B15. The method of embodiment B14, further comprising authenticating or rejecting the communication device depending at least in part on the indicated result.
   B16. The method of any of embodiments B1-B2 and B4-B15, wherein the challenge is a random token RAND* generated by the security anchor equipment.
   B17. The method of any of embodiments B1-B16, wherein the expected response is derived using a random token RAND* generated by the security anchor equipment.
   B18. The method of any of embodiments B16-B17, further comprising receiving the random token RAND* from the security anchor equipment.
   B19. The method of any of embodiments B1-B18, wherein the authentication server implements an Authentication Server Function, AUSF.
   B20. The method of any of embodiments B1-B19, wherein the authentication server is configured for use in a home network of the communication equipment.
   B21. The method of any of embodiments B1-B20, wherein the security anchor equipment is configured for use in a serving network of the communication equipment.

### Group C Embodiments

C1. A method performed by a communication device, the method comprising:
exchanging Extensible Authentication Protocol, EAP, messages with an authentication server as part of an EAP Authentication and Key Agreement, AKA, procedure between the communication device and the authentication server, with the authentication server operating as an EAP server;
receiving a challenge from security anchor equipment;
generating, from information used in the EAP AKA procedure between the communication device and the authentication server, a response to the challenge; and
transmitting the response to the security anchor equipment as part of an attempt to authenticate the communication device to the security anchor equipment.
   C2. The method of embodiment C1, wherein information used in the EAP AKA procedure between the communication device and the authentication server includes a random token RAND, wherein the response is derived using the random token RAND.
   C3. The method of embodiment C2, wherein the challenge is the random token RAND.
   C4. The method of any of embodiments C1-C3, wherein information used in the EAP AKA procedure between the communication device and the authentication server includes a cryptographic key, wherein the response is derived using the cryptographic key.
   C5. The method of embodiment C4, wherein the cryptographic key is shared between, or is generatable by each of, the communication device and the authentication server.
   C6. The method of any of embodiments C1-C5, wherein the response is a response RES*.
   C7. The method of any of embodiments C1-C5, wherein the response is a response CHECK**.
   C7.5. The method of any of embodiments C1-C7, wherein transmitting the response comprises transmitting the response to the security anchor equipment within an EAP AKA message.

C8. The method of any of embodiments C1-C7, wherein transmitting the response comprises transmitting the response to the security anchor equipment within a Non-Access Stratum, NAS, message.

C9. The method of any of embodiments C1-C8, wherein said deriving comprises deriving the response from a random token generated by the security anchor equipment.

C10. The method of embodiment C9, further comprising receiving the random token from the security anchor equipment.

C11. The method of embodiment C10, wherein the random token is received within a Non-Access Stratum, NAS, message.

C12. The method of any of embodiments C1-C11, further comprising receiving, from the security anchor equipment, signaling indicating a result of the attempt to authenticate the communication device to the security anchor equipment.

C13. The method of any of embodiments C1-C2 and C4-C12, wherein the challenge is a random token RAND* generated by the security anchor equipment.

C14. The method of any of embodiments C1-C13, wherein the response is derived using a random token RAND* generated by the security anchor equipment.

C15. The method of any of embodiments C13-C14, further comprising receiving the random token RAND* from the security anchor equipment.

C16. The method of any of embodiments C1-C15, further comprising receiving signaling indicating that the communication device is to generate the response.

C17. The method of any of embodiments C1-C16, wherein the authentication server is configured for use in a home network of the communication equipment.

C18. The method of any of embodiments C1-C17, wherein the security anchor equipment is configured for use in a serving network of the communication equipment.

### Group X Embodiments

X1. A method performed by security anchor equipment, the method comprising:
generating, by the security anchor equipment, a random token;
obtaining, by the security anchor equipment, an expected response that is derived using the random token and that is expected from a communication device in response to a challenge;
receiving, from the communication device, a response to the challenge; and
checking, by the security anchor equipment, whether the response corresponds to the expected response as part of an attempt to authenticate the communication device to the security anchor equipment.
   X2. The method of embodiment X1, wherein the challenge is the random token.
   X3. The method of any of embodiments X1-X2, further comprising:
transmitting the random token to an authentication server; and
after transmitting the random token, receiving the expected response from the authentication server.
   X3.5. The method of embodiment X3, wherein the expected response is received within a message that is not an EAP AKA message.
   X4. The method of embodiment X3, wherein the expected response is received within an Authentication, Authorization, and Accounting, AAA, message.
   X5. The method of embodiment X3, wherein the expected response is received within Serviced-Based Architecture, SBA, data carried in an application layer message.
   X6. The method of any of embodiments X1-X5, further comprising:
receiving a cryptographic key from the home network; and
generating the expected response from the cryptographic key and the random token.
   X7. The method of embodiment X6, further comprising transmitting a request for the cryptographic key to the authentication server, and wherein the cryptographic key is received in response to the request.
   X7.5. The method of any of embodiments X6-X7, wherein the cryptographic key is received within a message that is not an EAP AKA message.
   X8. The method of any of embodiments X6-X7, wherein the cryptographic key is received within an Authentication, Authorization, and Accounting, AAA, message.
   X9. The method of any of embodiments X6-X7, wherein the cryptographic key is received within Serviced-Based Architecture, SBA, data carried in an application layer message.
   X10. The method of any of embodiments X1-X9, wherein checking whether the response corresponds to the expected response comprises:
generating a response token from the response and the random token; and
checking whether the response token is equal to the expected response.
   X11. The method of any of embodiments X1-X10, further comprising transmitting the random token to the communication device.
   X12. The method of embodiment X11, wherein the random token is transmitted to the communication device within a Non-Access Stratum, NAS, message.
   X13. The method of any of embodiments X1-X12, further comprising relaying Extensible Authentication Protocol, EAP, messages between the communication device and the authentication server as part of an EAP Authentication and Key Agreement, AKA, procedure between the communication device and the authentication server, and wherein at least one of the response, the challenge, and the expected response is, or is derived using, information used in the EAP AKA procedure between the communication device and the authentication server.
   X14. The method of embodiment X13, wherein information used in the EAP AKA procedure between the communication device and the authentication server includes a random token RAND generated by the authentication server, wherein at least one of the response, the challenge, and the expected response is, or is derived using, the random token RAND generated by the authentication server.
   X15. The method of embodiment X14, wherein the challenge is the random token RAND generated by the authentication server.
   X16. The method of any of embodiments X14-X15, wherein the expected response is also derived using the random token RAND generated by the authentication server.
   X17. The method of embodiment X16, further comprising receiving the random token RAND from the authentication server.
   X18. The method of embodiment X17, further comprising receiving an EAP AKA message from the authentication server and retrieving the random token RAND from the EAP AKA message.
   X18.5. The method of embodiment X17, wherein the random token RAND is received in a message that is not an EAP AKA message.
   X19. The method of embodiment X17, wherein the random token RAND is received in either:
an Authentication, Authorization, and Accounting, AAA, message; or
Serviced-Based Architecture, SBA, data carried in an application layer message.
   X20. The method of any of embodiments X14-X19, wherein information used in the EAP AKA procedure between the communication device and the authentication server includes a cryptographic key, wherein the response and/or the expected response is derived using the cryptographic key.
   X21. The method of embodiment X20, wherein the cryptographic key is shared between, or is generatable by each of, the communication device and the authentication server.
   X22. The method of any of embodiments X1-X21, wherein the response is a response CHECK* and wherein the expected response is an expected check value XCHECK*.
   X23. The method of any of embodiments X1-X22, wherein the response is received from the communication device in a Non-Access Stratum, NAS, message.
   X24. The method of any of embodiments X1-X23, further comprising transmitting, to the authentication server and/or to the communication device, signaling indicating a result of said checking by the security anchor equipment.
   X25. The method of any of embodiments X1-X24, further comprising authenticating or rejecting the communication device depending on a result of said checking.
   X26. The method of any of embodiments X1-X25, wherein the security anchor equipment implements a Security Anchor Function, SEAF.
   X27. The method of any of embodiments X1-X26, wherein said checking is performed as part of, or during, a 5G AKA procedure between the communication device and the h authentication server.
   X28. The method of any of embodiments X1-X26, wherein said checking is performed as part of, or during, an EAP AKA procedure between the communication device and the authentication server.
   X29. The method of any of embodiments X1-X28, wherein the authentication server is configured for use in a home network of the communication equipment.
   X30. The method of any of embodiments X1-X29, wherein the security anchor equipment is configured for use in a serving network of the communication equipment.

### Group Y Embodiments

Y1. A method performed by an authentication server, the method comprising:
receiving a random token from security anchor equipment;
deriving, using the random token, an expected response that the security anchor equipment is to expect in response to a challenge as part of an attempt by the security anchor equipment to authenticate the communication device; and
transmitting the expected response to the security anchor equipment.
   Y2. The method of embodiment Y1, wherein the expected response is transmitted within a message that is not an EAP AKA message.
   Y3. The method of embodiment Y1, wherein the expected response is transmitted within an Authentication, Authorization, and Accounting, AAA, message.
   Y4. The method of embodiment Y1, wherein the expected response is transmitted within Serviced-Based Architecture, SBA, data carried in an application layer message.
   Y5. The method of any of embodiments Y1-Y4, further comprising exchanging Extensible Authentication Protocol, EAP, messages between the communication device and the authentication server as part of an EAP Authentication and Key Agreement, AKA, procedure between the communication device and the authentication server, and wherein at least one of the challenge and the expected response is, or is derived using, information used in the EAP AKA procedure between the communication device and the authentication server.
   Y6. The method of embodiment Y5, wherein information used in the EAP AKA procedure between the communication device and the authentication server includes a random token RAND generated by the authentication server, wherein deriving the expected response comprises deriving the expected response also using the random token RAND generated by the authentication server.
   Y7. The method of any of embodiments Y5-Y6, wherein information used in the EAP AKA procedure between the communication device and the authentication server includes a random token RAND generated by the authentication server, wherein the challenge is the random token RAND generated by the authentication server.
   Y8. The method of any of embodiments Y5-Y7, further comprising transmitting, from the authentication server to the security anchor equipment, the random token RAND generated by the authentication server.
   Y9. The method of embodiment Y8, further comprising transmitting an EAP AKA message from the authentication server to the security anchor equipment, wherein the random token generated by the authentication server is included in the EAP AKA message.
   Y10. The method of embodiment Y8, wherein transmitting, from the authentication server to the security anchor equipment, the random token RAND generated by the authentication server comprises transmitting the random token RAND generated by the authentication server in a message that is not an EAP AKA message.
   Y11. The method of embodiment Y8, wherein transmitting, from the authentication server to the security anchor equipment, the random token RAND generated by the authentication server comprises transmitting the random token RAND generated by the authentication server in either:
an Authentication, Authorization, and Accounting, AAA, message; or
Serviced-Based Architecture, SBA, data carried in an application layer message.
   Y12. The method of any of embodiments Y5-Y11, wherein information used in the EAP AKA procedure between the communication device and the authentication server includes a cryptographic key, wherein the expected response is derived also using the cryptographic key.
   Y13. The method of embodiment Y12, wherein the cryptographic key is shared between, or is generatable by each of, the communication device and the authentication server.
   Y14. The method of any of embodiments Y1-Y13, the expected response is an expected check value XCHECK*.
   Y15. The method of any of embodiments Y1-Y14, wherein the security anchor equipment implements a Security Anchor Function, SEAF.
   Y16. The method of any of embodiments Y1-Y15, wherein the attempt by the security anchor equipment to authenticate the communication device is performed as part of, or during, a 5G AKA procedure between the communication device and the authentication server.
   Y17. The method of any of embodiments Y1-Y15, wherein the attempt by the security anchor equipment to authenticate the communication device is performed as part of, or during, an EAP AKA procedure between the communication device and the authentication server.
   Y18. The method of any of embodiments Y1-Y17, wherein the authentication server is configured for use in a home network of the communication equipment.
   Y19. The method of any of embodiments Y1-Y18, wherein the security anchor equipment is configured for use in a serving network of the communication equipment.
   YY1. A method performed by an authentication server, the method comprising:
receiving, from security anchor equipment, a request for a cryptographic key based on which the security anchor equipment is to derive an expected response that the security anchor equipment is to expect in response to a challenge as part of an attempt by the security anchor equipment to authenticate the communication device;
generating the cryptographic key; and
transmitting the cryptographic key to the security anchor equipment.
   YY2. The method of embodiment YY1, wherein the cryptographic key is transmitted within a message that is not an EAP AKA message.
   YY3. The method of embodiment YY1, wherein the cryptographic key is transmitted within an Authentication, Authorization, and Accounting, AAA, message.
   YY4. The method of embodiment YY1, wherein the cryptographic key is transmitted within Serviced-Based Architecture, SBA, data carried in an application layer message.
   YY5. The method of any of embodiments YY1-YY4, further comprising exchanging Extensible Authentication Protocol, EAP, messages between the communication device and the authentication server as part of an EAP Authentication and Key Agreement, AKA, procedure between the communication device and the authentication server, and wherein at least one of the challenge and the expected response is, or is derived using, information used in the EAP AKA procedure between the communication device and the authentication server.
   YY6. The method of embodiment YY5, wherein information used in the EAP AKA procedure between the communication device and the authentication server includes a random token RAND generated by the authentication server, wherein the expected response is to be derived also using the random token RAND generated by the authentication server.
   YY7. The method of any of embodiments YY5-YY6, wherein information used in the EAP AKA procedure between the communication device and the authentication server includes a random token RAND generated by the authentication server, wherein the challenge is the random token RAND generated by the authentication server.
   YY8. The method of any of embodiments YY5-YY7, further comprising transmitting, from the authentication server to the security anchor equipment, the random token RAND generated by the authentication server.
   YY9. The method of embodiment YY8, further comprising transmitting an EAP AKA message from the authentication server to the security anchor equipment, wherein the random token generated by the authentication server is included in the EAP AKA message.
   YY10. The method of embodiment YY8, wherein transmitting, from the authentication server to the security anchor equipment, the random token RAND generated by the authentication server comprises transmitting the random token RAND generated by the authentication server in a message that is not an EAP AKA message.
   YY11. The method of embodiment YY8, wherein transmitting, from the authentication server to the security anchor equipment, the random token RAND generated by the authentication server comprises transmitting the random token RAND generated by the authentication server in either:
an Authentication, Authorization, and Accounting, AAA, message; or
Serviced-Based Architecture, SBA, data carried in an application layer message.
   YY12. The method of any of embodiments YY1-YY11, the expected response is an expected check value XCHECK*.
   YY13. The method of any of embodiments YY1-YY12, wherein the security anchor equipment implements a Security Anchor Function, SEAF.
   YY14. The method of any of embodiments YY1-YY13, wherein the attempt by the security anchor equipment to authenticate the communication device is performed as part of, or during, a 5G AKA procedure between the communication device and the authentication server.
   YY15. The method of any of embodiments YY1-YY13, wherein the attempt by the security anchor equipment to authenticate the communication device is performed as part of, or during, an EAP AKA procedure between the communication device and the authentication server.
   YY16. The method of any of embodiments YY1-YY15, wherein the authentication server is configured for use in a home network of the communication equipment.
   YY17. The method of any of embodiments YY1-YY16, wherein the security anchor equipment is configured for use in a serving network of the communication equipment.

### Group Z Embodiments

Z1. A method performed by a communication device, the method comprising:
receiving a random token generated by security anchor equipment;
receiving a challenge from the security anchor equipment;
generating, from the random token, a response to the challenge as part of an attempt to authenticate the communication device to the security anchor equipment; and
transmitting the response to the security anchor equipment.
   Z2. The method of embodiment Z1, wherein the response is transmitted within a message that is not an EAP AKA message.
   Z3. The method of embodiment Z1, wherein the response is transmitted within an Authentication, Authorization, and Accounting, AAA, message.
   Z4. The method of embodiment Z1, wherein the response is transmitted within Serviced-Based Architecture, SBA, data carried in an application layer message.
   Z5. The method of any of embodiments Z1-Z4, further comprising exchanging Extensible Authentication Protocol, EAP, messages between the communication device and an authentication server as part of an EAP Authentication and Key Agreement, AKA, procedure between the communication device and the authentication server, and wherein at least one of the challenge and the response is, or is derived using, information used in the EAP AKA procedure between the communication device and the authentication server.
   Z6. The method of embodiment Z5, wherein information used in the EAP AKA procedure between the communication device and the authentication server includes a random token RAND generated by the authentication server, wherein deriving the response comprises deriving the response also using the random token RAND generated by the authentication server.
   Z7. The method of any of embodiments Z5-Z6, wherein information used in the EAP AKA procedure between the communication device and the authentication server includes a random token RAND generated by the authentication server, wherein the challenge is the random token RAND generated by the authentication server.
   Z8. The method of any of embodiments Z1-Z7, wherein the random token generated by security anchor equipment is received in an EAP AKA message.
   Z9. The method of any of embodiments Z1-Z7, wherein the random token generated by security anchor equipment is received in a message that is not an EAP AKA message.
   Z10. The method of any of embodiments Z1-Z7, wherein the random token generated by security anchor equipment is received in either:
an Authentication, Authorization, and Accounting, AAA, message; or
Serviced-Based Architecture, SBA, data carried in an application layer message.
   Z11. The method of any of embodiments Z1-Z10, the response is a check value CHECK*.
   Z12. The method of any of embodiments Z1-Z11, wherein the security anchor equipment implements a Security Anchor Function, SEAF.
   Z13. The method of any of embodiments Z1-Z12, wherein the attempt by the security anchor equipment to authenticate the communication device is performed as part of, or during, a 5G AKA procedure between the communication device and the authentication server.
   Z14. The method of any of embodiments Z1-Z12, wherein the attempt by the security anchor equipment to authenticate the communication device is performed as part of, or during, an EAP AKA procedure between the communication device and the authentication server.
   Z15. The method of any of embodiments Z1-Z14, wherein the authentication server is configured for use in a home network of the communication equipment.
   Z16. The method of any of embodiments Z1-Z15, wherein the security anchor equipment is configured for use in a serving network of the communication equipment.

### Group E Embodiments

E1. A wireless device configured to perform any of the steps of any of the Group C or Group Z embodiments.
E2. A wireless device comprising processing circuitry configured to perform any of the steps of any of the Group C or Group Z embodiments.
E3. A wireless device comprising:
communication circuitry; and
processing circuitry configured to perform any of the steps of any of the Group C or Group Z embodiments.
   E4. A wireless device comprising:
processing circuitry configured to perform any of the steps of any of the Group C or Group Z embodiments; and
power supply circuitry configured to supply power to the wireless device.
   E5. A wireless device comprising:
processing circuitry and memory, the memory containing instructions executable by the processing circuitry whereby the wireless device is configured to perform any of the steps of any of the Group C or Group Z embodiments.
   E6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group C or Group Z embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   E7. A computer program comprising instructions which, when executed by at least one processor of a wireless device, causes the wireless device to carry out the steps of any of the Group C or Group Z embodiments.
   E8. A carrier containing the computer program of embodiment E7, wherein the carrier is one of an electronic signal, optical signal, radio signal, or computer readable storage medium.
   E9. Security anchor equipment configured to perform any of the steps of any of the Group A or Group X embodiments.
   E10. Security anchor equipment comprising processing circuitry configured to perform any of the steps of any of the Group A or Group X embodiments.
   E11. Security anchor equipment comprising:
communication circuitry; and
processing circuitry configured to perform any of the steps of any of the Group A or Group X embodiments.
   E12. Security anchor equipment comprising:
processing circuitry configured to perform any of the steps of any of the Group A or Group X embodiments;
power supply circuitry configured to supply power to the security anchor equipment.
   E13. Security anchor equipment comprising:
processing circuitry and memory, the memory containing instructions executable by the processing circuitry whereby the security anchor equipment is configured to perform any of the steps of any of the Group A or Group X embodiments.
   E14. A computer program comprising instructions which, when executed by at least one processor of security anchor equipment, causes the security anchor equipment to carry out the steps of any of the Group A or Group X embodiments.
   E15. A carrier containing the computer program of embodiment E15, wherein the carrier is one of an electronic signal, optical signal, radio signal, or computer readable storage medium.
   E16. An authentication server configured to perform any of the steps of any of the Group B or Group Y embodiments.
   E17. An authentication server comprising processing circuitry configured to perform any of the steps of any of the Group B or Group Y embodiments.
   E18. An authentication server comprising:
communication circuitry; and
processing circuitry configured to perform any of the steps of any of the Group B or Group Y embodiments.
   E19. An authentication server comprising:
processing circuitry configured to perform any of the steps of any of the Group B or Group Y embodiments;
power supply circuitry configured to supply power to the authentication server.
   E20. An authentication server comprising:
processing circuitry and memory, the memory containing instructions executable by the processing circuitry whereby the authentication server is configured to perform any of the steps of any of the Group B or Group Y embodiments.
   E21. A computer program comprising instructions which, when executed by at least one processor of an authentication server, causes the authentication server to carry out the steps of any of the Group B or Group Y embodiments.
   E22. A carrier containing the computer program of embodiment E21, wherein the carrier is one of an electronic signal, optical signal, radio signal, or computer readable storage medium.

1.-47. (canceled)

48. A method performed by security anchor equipment, the method comprising:
relaying Extensible Authentication Protocol (EAP) messages between a communication device and an authentication server that is operating as an EAP server for an EAP Authentication and Key Agreement (AKA) procedure between the communication device and the authentication server;
receiving, from the communication device, a response to a challenge; and
checking, by the security anchor equipment, whether the response corresponds to an expected response as part of an attempt by the security anchor equipment to authenticate the communication device, wherein at least one of the response, the challenge, and the expected response is, or is derived using, information used in the EAP AKA procedure between the communication device and the authentication server.

49. The method of claim 48, wherein information used in the EAP AKA procedure between the communication device and the authentication server includes a random token RAND, wherein at least one of the response, the challenge, and the expected response is, or is derived using, the random token RAND.

50. The method of claim 49, wherein the response and/or the expected response is derived using the random token RAND, and wherein the method further comprises receiving the random token RAND from the authentication server.

51. The method of claim 50, wherein:
checking whether the response corresponds to the expected response comprises generating a response token from the response and the random token RAND and checking whether the response token is equal to the expected response;
and/or the random token RAND is received in either an Authentication, Authorization, and Accounting (AAA) message or Serviced-Based Architecture (SBA) data carried in an application layer message.

52. The method of claim 48, wherein information used in the EAP AKA procedure between the communication device and the authentication server includes a cryptographic key that is shared between, or is generatable by each of, the communication device and the authentication server, wherein the response and/or the expected response is derived using the cryptographic key.

53. The method of claim 48, wherein the expected response is derived using information used in the EAP AKA procedure between the communication device and the authentication server, wherein either:
the response is a response RES* and the expected response is an expected response HXRES*; or
the response is a response CHECK* and the expected response is an expected check value XCHECK*.

54. The method of claim 48, further comprising receiving the expected response from the authentication server, wherein the expected response is received within an Authentication, Authorization, and Accounting (AAA) message or is received within Serviced-Based Architecture (SBA) data carried in an application layer message; or
wherein information used in the EAP AKA procedure between the communication device and the authentication server includes a random token RAND, and wherein the method further comprises deriving the expected response from the random token RAND.

55. The method of claim 54, wherein said deriving comprises deriving the expected response also using
a random token generated by the security anchor equipment; and/or
a cryptographic key received from the authentication server.

56. The method of claim 48, further comprising
transmitting, to the authentication server and/or to the communication device, signaling indicating a result of said checking by the security anchor equipment; and/or
authenticating or rejecting the communication device depending on a result of said checking.

57. The method of claim 48, wherein the challenge is a random token RAND* generated by the security anchor equipment and/or wherein the expected response is derived using a random token RAND* generated by the security anchor equipment.

58. A method performed by an authentication server, the method comprising:
exchanging Extensible Authentication Protocol (EAP) messages with a communication device as part of an EAP Authentication and Key Agreement (AKA) procedure between the communication device and the authentication server, with the authentication server operating as an EAP server;
deriving, from information used in the EAP AKA procedure between the communication device and the authentication server, an expected response that security anchor equipment is to expect in response to a challenge as part of an attempt by the security anchor equipment to authenticate the communication device; and
transmitting the expected response to the security anchor equipment.

59. The method of claim 58, wherein information used in the EAP AKA procedure between the communication device and the authentication server includes
a random token RAND, wherein the expected response is derived using the random token RAND; and/or
a cryptographic key that is shared between, or is generatable by each of, the communication device and the authentication server, wherein the expected response is derived using the cryptographic key.

60. The method of claim 58, wherein:
the expected response is an expected response HXRES* or is an expected check value XCHECK*; and/or
transmitting the expected response comprises transmitting the expected response to the security anchor equipment within an Authentication, Authorization, and Accounting (AAA) message or within Serviced-Based Architecture (SBA) data carried in an application layer message.

61. The method of claim 58, further comprising receiving a random token from the security anchor equipment, and wherein said deriving comprises deriving the expected response also from the random token received from the security anchor equipment.

62. The method of claim 58, further comprising:
receiving, from the security anchor equipment, signaling indicating a result of the attempt by the security anchor equipment to authenticate the communication device; and
authenticating or rejecting the communication device depending at least in part on the indicated result.

63. The method of claim 58, further comprising receiving a random token RAND* from the security anchor equipment, wherein the challenge is the random token RAND* and/or wherein the expected response is derived using the random token RAND*.

64. A method performed by a communication device, the method comprising:
exchanging Extensible Authentication Protocol (EAP) messages with an authentication server as part of an EAP Authentication and Key Agreement (AKA) procedure between the communication device and the authentication server, with the authentication server operating as an EAP server;
receiving a challenge from security anchor equipment;
generating, from information used in the EAP AKA procedure between the communication device and the authentication server, a response to the challenge; and
transmitting the response to the security anchor equipment as part of an attempt to authenticate the communication device to the security anchor equipment.

65. The method of claim 64, wherein information used in the EAP AKA procedure between the communication device and the authentication server includes a random token RAND, wherein the response is derived using the random token RAND.

66. The method of claim 64, wherein:
the response is a response RES* or is a response CHECK*; or
information used in the EAP AKA procedure between the communication device and the authentication server includes a cryptographic key that is shared between, or is generatable by each of, the communication device and the authentication server, wherein the response is derived using the cryptographic key.

67. The method of claim 64, wherein transmitting the response comprises transmitting the response to the security anchor equipment within a Non-Access Stratum (NAS) message.

68. The method of claim 64, further comprising
receiving a random token from the security anchor equipment and wherein said deriving comprises deriving the response from the random token received from the security anchor equipment; and/or
receiving, from the security anchor equipment, signaling indicating a result of the attempt to authenticate the communication device to the security anchor equipment.

69. A communication device comprising:
communication circuitry; and
processing circuitry configured to:
exchange Extensible Authentication Protocol (EAP) messages with an authentication server as part of an EAP Authentication and Key Agreement (AKA) procedure between the communication device and the authentication server, with the authentication server operating as an EAP server;
receive a challenge from security anchor equipment;
generate, from information used in the EAP AKA procedure between the communication device and the authentication server, a response to the challenge; and
transmit the response to the security anchor equipment as part of an attempt to authenticate the communication device to the security anchor equipment.
